(19) United States
(12) Patent Application Publication
(10) Pub. No.: US 2019/0212138 A1
(43) Pub. Date: Jul. 11, 2019

(54) ROAD SURFACE STATE DETERMINATION METHOD AND ROAD SURFACE STATE DETERMINATION APPARATUS

(71) Applicant: BRIDGESTONE CORPORATION, Tokyo (JP)

(72) Inventors: Yasushi HANATSUKA, Tokyo (JP); Takato GOTO, Tokyo (JP)

(73) Assignee: Bridgestone Corporation, Tokyo (JP)

(21) Appl. No.: 16/312,670

(22) PCT Filed: Jun. 29, 2017
(86) PCT No.: PCT/JP2017/024014

§ 371 Date: Dec. 21, 2018

(30) Foreign Application Priority Data
Jun. 30, 2016 (JP) 2016-131083
Jun. 30, 2016 (JP) 2016-131084

(51) Int. Cl. G01B 17/08; B60C 23/04; B60C 23/06; G01W 1/00

(52) U.S. Cl. CPC G01B 17/08; B60C 23/0488; B60T 8/172; G01W 1/00; B60T 2210/14; B60C 23/065

(57) ABSTRACT

In order to provide a method for accurately determining the road surface state even when the tire state and external information change, when determining the state of the road surface from the time-varying waveform of vibration of a tire during travel detected by a vibration detection means, in addition to the vibration waveform of the tire, tire state information and external information inputted to the tire are acquired, and a determination parameter for determining the road surface state calculated from the tire vibration waveform is corrected or modified on the basis of the acquired tire state information or external information, and either the road surface state is determined using said corrected or modified determination parameter, or the road surface state is determined from the determination parameter and the state information or external information.

### TECHNICAL FIELD

The present invention relates to a method and an apparatus for determining a road surface state during travel.

### BACKGROUND ART

Conventionally, as a method for determining a road surface state, there is a method of determining a road surface state during travel on the basis of a value obtained by dividing a vibration waveform of a tire tread during travel detected by an acceleration sensor disposed in an inner liner portion of a tire into a pre-leading region R1 before a peak on the leading side appearing at a leading end, a leading region R2 in which the peak on the leading side is formed, a pre-trailing region R3 between the peak on the leading side and a peak on the trailing side appearing at a trailing end, a trailing region R4 in which the peak on the trailing side is formed, and a post-trailing region R5 after the trailing region R4, performing frequency analysis on the vibration waveform of each region, obtaining a plurality of band values Pᵢⱼ serving as vibration levels of specific frequency bands from obtained frequency spectra, and using these band values Pᵢⱼ in a discriminant function F(Pᵢⱼ) that has been obtained in advance is proposed (for example, see Patent Literature 1).

To be noted, the band values Pᵢⱼ described above each represent a band value whose number of region number is i and whose number of frequency band is j.

### CITATION LIST

### Patent Literature

### Patent Literature 1: Japanese Patent Application Publication No. 2011-242303

### SUMMARY OF INVENTION

### Technical Problems

However, in Patent Literature 1 described above, the fact that the time widths of the regions R1 to R5, the magnitudes of the band values Pᵢⱼ, and so forth change depending on a tire state such as tire inner pressure or tire inner temperature, or external information input to the tire such as braking/driving force or lateral force is not taken into consideration, and therefore the determination accuracy of the road surface state is not sufficient.

The present invention has been made in consideration of the conventional problem, and aims to provide a method and an apparatus capable of determining the road surface state with high accuracy even in the case where the tire state or the external information input to the tire has changed.

### Solution to Problems

The present invention is a road surface state determination method for determining a state of a road surface from a time-varying waveform of vibration of a tire during travel detected by a vibration detection means. The road surface state determination method includes a step of obtaining a vibration waveform of the tire, a step of obtaining state information of the tire, and either one determination step of a first determination step of determining a road surface state from a determination parameter that is obtained from the vibration waveform and is for determining the road surface state, and from the state information, and a second determination step of determining the road surface state, after correcting or changing the determination parameter by using the state information, from the corrected determination parameter.

As described above, since the determination parameter for determining the road surface state is corrected or changed in accordance with the obtained state information of the tire, the determination accuracy of the road surface state can be improved.

In addition, the present invention is a road surface state determination apparatus including a vibration detection means that detects vibration of a tire during travel, a vibration waveform detection means that detects a time-varying waveform of the vibration of the tire, and a road surface state determination means that determines a state of a road surface from the time-varying waveform, wherein a tire state detection means that obtains state information of the tire is provided, and wherein the road surface state determination means determines a road surface state from a determination parameter that is obtained from the vibration waveform and is for determining the road surface state, and from the state information.

By employing such a configuration, a road surface state determination apparatus having high determination accuracy of road surface state can be provided.

In addition, the present invention is a road surface state determination method for determining a state of a road surface from a time-varying waveform of vibration of a tire during travel detected by a vibration detection means. The road surface state determination method includes a step of obtaining a vibration waveform of the tire, a step of obtaining external information input to the tire, and either one determination step of a first determination step of determining a road surface state from a determination parameter that is obtained from the vibration waveform and is for determining the road surface state, and from the external information, and a second determination step of determining the road surface state, after correcting or changing the determination parameter by using the external information, from the corrected determination parameter.

As described above, since the determination parameter for determining the road surface state is corrected or changed in accordance with the obtained external information input to the tire, the determination accuracy of the road surface state can be improved.

To be note, the summary of the invention described above is not a list of all features required for the present invention, and subcombinations of these features can be the invention.

### BRIEF DESCRIPTION OF DRAWINGS

FIG. 1 is a diagram illustrating a configuration of a road surface state determination apparatus according to Embodiment 1 of the present invention.

FIG. 2 is a diagram illustrating an example of arrangement of an acceleration sensor.

FIG. 3 is a diagram illustrating an example of a time series waveform of vibration and extraction regions of band values.

FIG. 4 is a diagram illustrating a relationship between band values and tire inner pressure.

FIG. 5 is a flowchart illustrating a road surface state determination method according to Embodiment 1 of the present invention.

FIG. 6 is a diagram illustrating a relationship between suitable frequency bands and tire inner pressure.

FIG. 7 is a diagram illustrating a configuration of a road surface state determination apparatus according to Embodiment 2 of the present invention.

FIG. 8 is a diagram illustrating a method for extracting a time series waveform of tire vibration for each time window.

FIG. 9 is a diagram illustrating an example of a road surface HMM.

FIG. 10 is a diagram illustrating a road surface HMM used for calculation of likelihood.

FIG. 11 is a schematic diagram of a state transition series.

FIG. 12 is a flowchart illustrating a road surface state determination method according to Embodiment 2 of the present invention.

FIG. 13 is a diagram illustrating a configuration of a road surface state determination apparatus according to Embodiment 3.

FIG. 14 is a schematic diagram illustrating an input space.

FIG. 15 is a diagram illustrating DRY road surface feature vectors and feature vectors not of a DRY road surface in an input space.

FIG. 16 is a diagram illustrating a calculation method for a GA kernel of DRY road surface feature vectors and feature vectors not of a DRY road surface.

FIG. 17 is a diagram illustrating a calculation method for a GA kernel of calculated feature vectors and road surface feature vectors.

FIG. 18 is a flowchart illustrating a road surface state determination method according to Embodiment 3 of the present invention.

FIG. 19 is a diagram illustrating a configuration of a road surface state determination apparatus according to Embodiment 4.

FIG. 20 is a diagram illustrating an example of arrangement of an acceleration sensor.

FIG. 21 is a diagram illustrating an example of a time series waveform of vibration and extraction regions of band values.

FIG. 22 is a diagram illustrating a relationship between band values and braking/driving force.

FIG. 23 is a flowchart illustrating a road surface state determination method according to Embodiment 4 of the present invention.

FIG. 24 is a diagram illustrating a relationship between suitable frequency bands and braking/driving force.

FIG. 25 is a diagram illustrating a configuration of a road surface state determination apparatus according to Embodiment 5 of the present invention.

FIG. 26 is a diagram illustrating a method for extracting a time series waveform of tire vibration for each time window.

FIG. 27 is a diagram illustrating an example of a road surface HMM.

FIG. 28 is a diagram illustrating a road surface HMM used for calculation of likelihood.

FIG. 29 is a schematic diagram of a state transition series.

FIG. 30 is a flowchart illustrating a road surface state determination method according to Embodiment 5 of the present invention.

FIG. 31 is a diagram illustrating a configuration of a road surface state determination apparatus according to Embodiment 6.

FIG. 32 is a schematic diagram illustrating an input space.

FIG. 33 is a diagram illustrating DRY road surface feature vectors and feature vectors not of a DRY road surface in an input space.

FIG. 34 is a diagram illustrating a calculation method for a GA kernel of DRY road surface feature vectors and feature vectors not of a DRY road surface.

FIG. 35 is a diagram illustrating a calculation method for a GA kernel of calculated feature vectors and road surface feature vectors.

FIG. 36 is a flowchart illustrating a road surface state determination method according to Embodiment 6 of the present invention.

### DESCRIPTION OF EMBODIMENTS

### Embodiment 1

FIG. 1 is a function block diagram of a road surface state determination apparatus 10 according to the present embodiment. In this figure, 11 represents an acceleration sensor serving as a vibration detection means, 12 represents an inner pressure sensor serving as a tire state detection means, 13 represents a tire state determination means, 14 represents a vibration waveform detection means, 15 represents a region signal detection means, 16 represents a band value calculation means, 17 represents a band value correction means, and 18 represents a road surface state determination means.

The acceleration sensor 11 and the inner pressure sensor 12 constitutes a sensor portion 10A, and means from the vibration waveform detection means 13 to the road surface state determination means 18 constitute a storage/calculation portion 10B.

Each means constituting the storage/calculation portion 10B is constituted by, for example, software of a computer and a storage device such as a RAM.

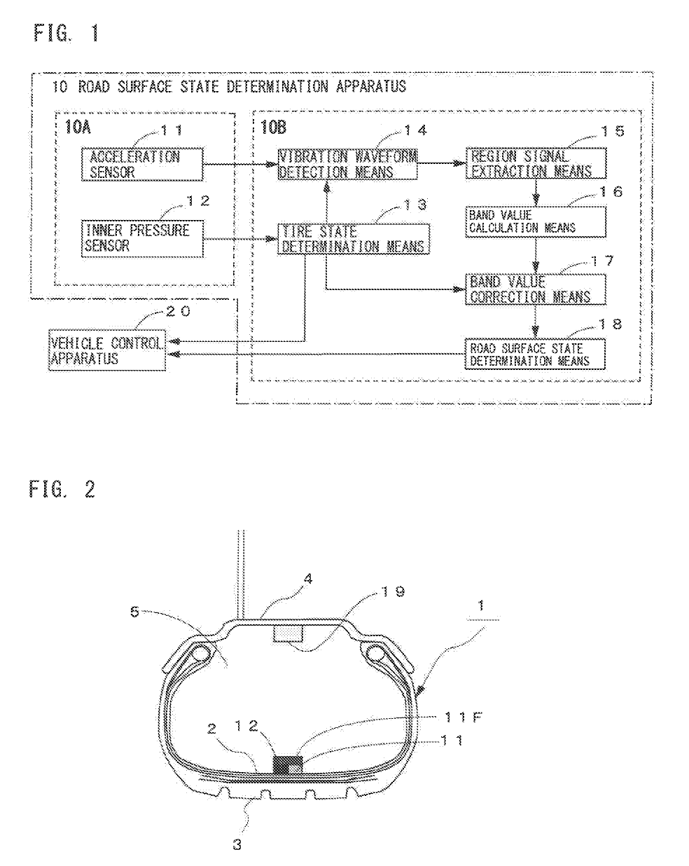

As illustrated in FIG. 2, the acceleration sensor 11 is disposed at the center of an inner liner portion 2 of a tire 1 in a tire width direction such that the detection direction thereof is a tire circumferential direction. As a result of this, the acceleration sensor 11 detects an acceleration rate in the tire circumferential direction input applied from a road surface to a tread 3. Hereinafter, a position of the acceleration sensor 11 (strictly, a position on the surface of the tread 3 disposed on the outside of the acceleration sensor 11 in the radial direction) will be referred to as a measurement point.

For example, output of the acceleration sensor 11 is transmitted by a transmitter 11F to the vibration waveform detection means 14 of an unillustrated storage/calculation portion 10B provided on the vehicle body side. In addition, a determination result of the road surface state determination apparatus 10 is transmitted to a vehicle control apparatus 20 disposed on the vehicle body side.

In addition, the inner pressure sensor 12 is integrally provided with the acceleration sensor 11, and measures a pressure (hereinafter referred to as tire inner pressure) P inside the tire 1. The measured tire inner pressure P is transmitted to the tire state determination means 13 of the storage/calculation portion 10B by the transmitter 11F.

To be noted, a configuration in which the storage/calculation portion 10B is provided on the tire 1 side and the determination result of the road surface state determination apparatus 10 is transmitted to the vehicle control apparatus 20 provided on the vehicle body side may be employed.

The tire state determination means 13 determines, from the tire inner pressure P measured by the inner pressure sensor 12, whether or not the tire 1 is in a state in which determination of the road surface state is possible. Specifically, whether or not the measured tire inner pressure P is within a preset determinable inner pressure range [Pₘᵢₙ, P_{Max}], and in the case where P<Pₘᵢₙ or P>P_{Max} holds, it is determined that it is difficult to determine the road surface state from the detected vibration waveform, a stop instruction signal for stopping detection of the vibration waveform is transmitted to the vibration waveform detection means 14, and an undeterminable signal indicating that the accuracy of the road surface state determined from the detected vibration waveform is low is transmitted to the vehicle control apparatus 20.

In contrast, in the case where the measured tire inner pressure P is within the determinable inner pressure range [Pₘᵢₙ, P_{Max}], measurement data of the tire inner pressure P is output to the band value correction means 17.

To be noted, the determinable inner pressure range [Pₘᵢₙ, P_{Max}] varies depending on a tire type, and, for example, in the case where a standard inner pressure is P₀, it is preferable that Pₘᵢₙ=(1−0.3)P₀ and P_{Max}=(1+0.3)P₀ or Pₘᵢₙ=P₀−100 kPa and P_{Max}=P₀+100 kPa are satisfied.

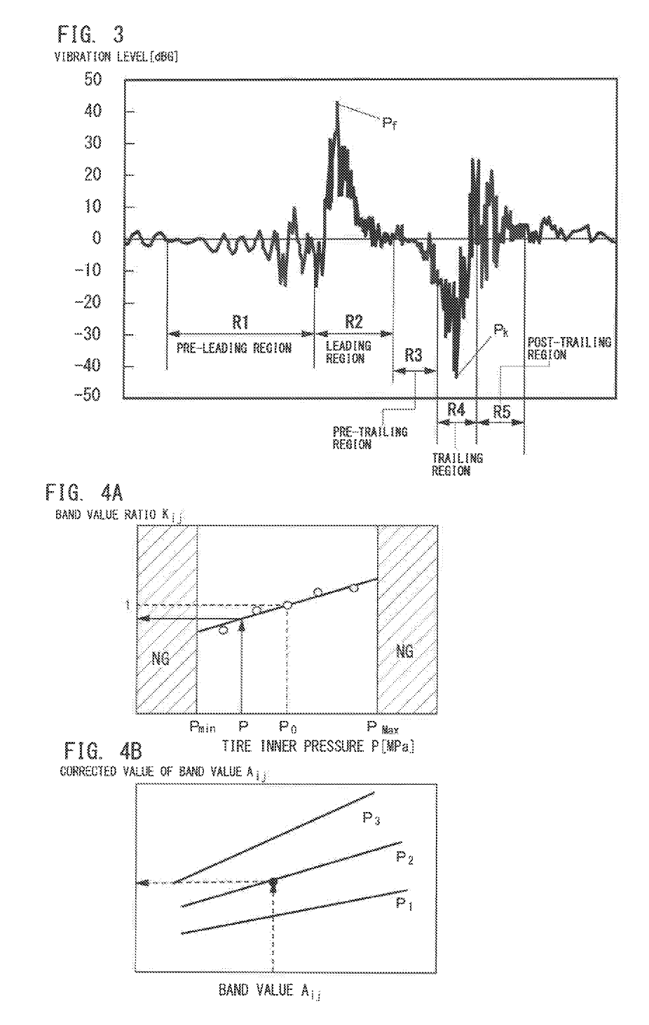

The vibration waveform detection means 14 detects a time series waveform in which vibration in the tire circumferential direction input to the tire 1 during travel, which is an output of the acceleration sensor 11, is arranged in time series. As illustrated in FIG. 3, a peak (positive peak) P_{f} appearing first in the time series waveform of vibration is a peak generated when a measurement point collides with a road surface, and the position of this peak P_{f} is a leading point P_{f}. A peak (negative peak) Pₖ appearing next is a peak generated when the measurement point is separated from the road surface, and the position of this peak Pₖ is a trailing point.

The region signal extraction means 15 divides the time series waveform detected by the vibration waveform detection means 13 into the pre-leading region R1 before the peak P_{f} on the leading side, the leading region R2 in which the peak P_{f} on the leading side is formed, the pre-trailing region R3 which is a region between the peak P_{f} on the leading side and the peak Pₖ on the trailing side, the trailing region R4 in which the peak Pₖ on the trailing side is formed, and the post-trailing region R5 after the trailing region R4, and thus extracts a time series waveform of vibration in each of the regions R1 to R5.

To be noted, in the case where the stop instruction signal has been input from the tire state determination means 13, the extraction operation of the time series waveform is stopped.

The band value calculation means 16 subject the respective time series waveforms of the regions R1 to R5 to band-pass filter, and calculates band values Aᵢⱼ, which are magnitudes of vibration components in predetermined frequency regions. To be noted, the affix i indicates the regions R1 to R5 of the time series waveform, and the affix j indicates an extracted frequency region.

For example, A₁₁ is a band value selected from a 2 kHz-8 kHz hand of the pre-leading region R1, A₂₃ is a band value selected from a 4 kHz-10 kHz band of the leading region R2, and A₅₂ is a band value selected from a 2 kHz-4 kHz band of the post-trailing region R5.

This band value Aᵢⱼ corresponds to a determination parameter of the present invention. The band value correction means 17 corrects the band value Aᵢⱼ calculated by the band value calculation means 16 by using data of the tire inner pressure P transmitted from the tire state determination means 13. Specifically, a graph illustrating a relationship between the tire inner pressure P and a band value ratio Kᵢⱼ=aᵢⱼ(P)/aᵢⱼ(P₀) as illustrated in FIG. 4 is prepared, and a band value Aᵢⱼ(P) when the inner pressure is P is corrected.

When a corrected band value is expressed as Aᵢⱼ(P), Aᵢⱼ(P)=Kᵢⱼ×Aᵢⱼ holds.

To be noted, not all the band values Aᵢⱼ increase as the tire inner pressure P increases as illustrated in FIG. 4A. Some band values Aᵢⱼ decrease as the tire inner pressure P increases. Therefore, as described above, regarding a relationship between the band values Aᵢⱼ and the tire inner pressure P, data indicating the relationship between the tire inner pressure P and the band value ratio Kᵢⱼ needs to be prepared for each extraction region Ri and extraction frequency region j.

To be noted, the method for correcting the band values Aᵢⱼ is not limited to the method described above, and, as illustrated in FIG. 4B, a straight line or a curved line indicating a relationship between Aᵢⱼ and Aᵢⱼ(P) may be obtained in advance for each tire inner pressure P, and Aᵢⱼ(P) on the straight line or curved line corresponding to a tire inner pressure P with which Aᵢⱼ has been measured may be used as a corrected value.

The road surface state determination means 18 estimates the road surface state by using a function value fk obtained by using the band value Aᵢⱼ(P) corrected by the band value correction means 17 instead of Aᵢⱼ calculated by the band value calculation means 16 in a plurality of preset discriminant functions Fk(Aᵢⱼ).

In this example, as the discriminant functions Fk, a discriminant function F1=w₁₁·A₁₁+w₁₂·A₁₂−K1 for determining whether or not an interposed matter such as water or snow is present on the road surface, F2=w₂₁·A₂₁+w₂₂·A₅₁−K2 for determining whether or not the road surface is a snow-covered surface, and F3=w₃₁·A₅₂+w₃₂·A₃₁+w₃₃·A₄₁+w₃₄·A₅₃, for determining which of water and snow the interposed matter on the road surface is, that is, which of a deep WET road surface and a deep sherbet-like snow road the road surface is, which the present applicant has proposed in Japanese Patent Application No. 2010-115730 (Patent Literature 1), are used, and whether or not the road surface is a “snow road” and which of a “snow-covered road” and a “shallow sherbet-like snow road” the “snow road” is are determined.

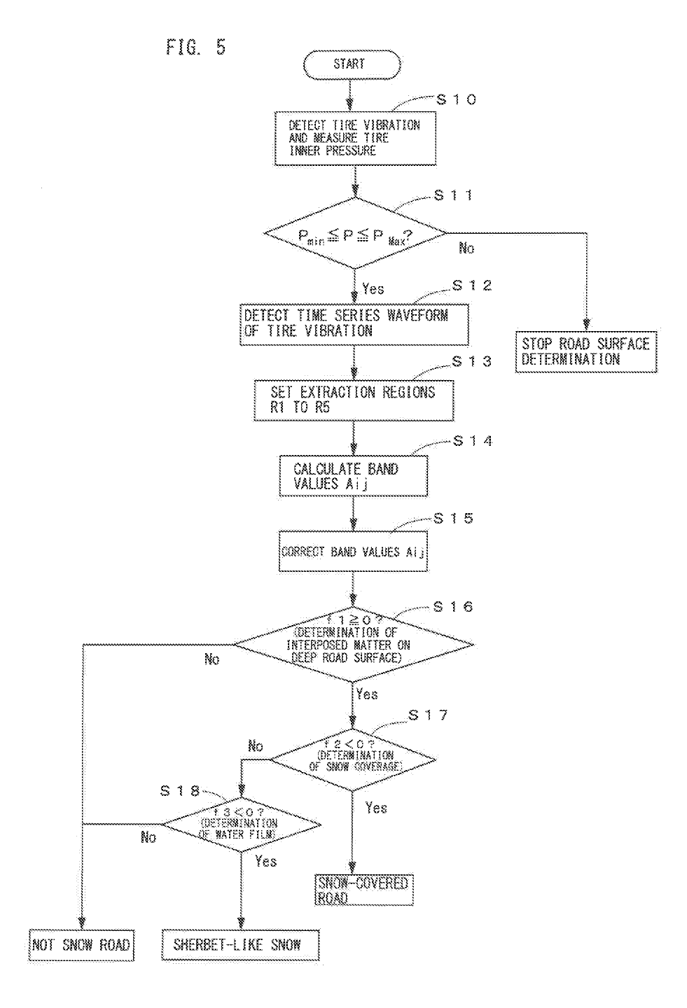

Next, a road surface state determination method according to Embodiment 1 will be described with reference to a flowchart of FIG. 5.

First, vibration in the tire circumferential direction of the tire 1 during travel is detected by the acceleration sensor 11, and the tire inner pressure is measured by the inner pressure sensor 12 (step S10).

Next, whether or not the tire inner pressure P is within the preset determinable inner pressure range [Pₘᵢₙ, P_{Max}] is determined from the measured tire inner pressure (step S11).

In the case where the tire inner pressure P is within the determinable inner pressure range [Pₘᵢₙ, P_{Max}], the process proceeds to step S12, and a time series waveform in which the vibration in the tire circumferential direction, which is output of the acceleration sensor 11, is arranged in time series is detected. In contrast, in the case where the measured tire inner pressure P satisfies P<Pₘᵢₙ or P>P_{Max}, the road surface determination operation is stopped. To be noted, whether or not the measured tire inner pressure P is within the determinable inner pressure range [Pₘᵢₙ, P_{Max}] may be determined again after a predetermined time has elapsed.

Next, the detected time series waveform is divided into the pre-leading region R1, the leading region R2, the pre-trailing region R3, the trailing region R4, and the post-trailing region R5 (step S13), and then the band values Aᵢⱼ are calculated from time series waveforms of vibration in the respective regions R1 to R5 (step S14).

The band values Aᵢⱼ are band values whose extraction region of time series waveform is Ri and whose frequency region is [fⱼₐ, f_{jb}]. For example, A₂₃ is a band value of the leading region R2 in a frequency region [4 kHz, 10 kHz].

In the present invention, the calculated band values A; are corrected by using data of the tire inner pressure P (step S15). To be noted, the correction is performed on each band value Aᵢⱼ.

Next, whether or not there is an interposed matter such as water or snow on the road surface is determined (step S16).

Specifically, a discriminant function F1=w₁₁·A₁₁+w₁₂·A₁₂−K1 is set by experimentally obtaining a relationship between a band value A₁₁ and a band value A₁₂ in various road surface states in advance, and a function value f1 is obtained by using, as a band value A₁₁ and a band value A₁₂ in this discriminant function F1, a band value A₁₁(P) and a band value A₁₂(P) that have been respectively corrected by using the tire inner pressure P.

In the case where the function value f1 satisfies f1≥0, it is determined that an interposed matter such as water or snow is present on the road surface, therefore the process proceeds to step S17, and whether or not the interposed matter on the road surface is soft fresh snow that has piled up is determined. In contrast, in the case where f1<0 holds, it is determined that the road surface is “not a snow road”.

In step S17, whether or not it is a snow-covered road on which fresh snow has piled up is determined.

Specifically, a discriminant function F2=w₂₁·A₂₁+w₂₂·A₅₁−K2 is set by experimentally obtaining a relationship between a band value A₂₁ and a band value A₅₁ in various road surface states in advance, and a function value f2 is obtained by using, as a band value A₂₁ and a band value A₅₁ in this discriminant function F2, a band value A₂₁(P) and a band value A₅₁(P) that have been respectively corrected by using the tire inner pressure P. In the case where f2<0 holds, it is determined that the road surface is a snow-covered road.

In contrast, in the case where the function value f2 satisfies f2≥0, the process proceeds step S18, and which of water and snow the interposed matter on the road surface is, that is, which of a deep WET road surface and a deep sherbet-like snow road the road surface is is determined.

That is, in step S18, a discriminant function F3=w₃₁·A₅₂+w₃₂·A₃₁+w₃₃·A₄₁+w₃₄·A₅₃ is set for band values A₅₂, A₃₁, A₄₁, and A₅₃ in various road surface states, and a function value f3 is obtained by using, as band values A₅₂, A₅₃₁, A₄₁, and A₅₃ in this discriminant function F3, band values A₅₂(P), A₃₁(P), A₄₁(P), and A₅₃(P) that have been respectively corrected by using the tire inner pressure P. In the case where f3≥0 holds, determination is made as a deep WET road (not a snow mad), and in the case where f3<0 holds, the road surface is determined as a sherbet-like snow road.

As described above, in Embodiment 1, the vibration in the tire circumferential direction of the tire 1 during travel is detected by the acceleration sensor 11, the tire inner pressure P is measured by the inner pressure sensor 12, and in the case where the measured tire inner pressure P is within the determinable inner pressure range [Pₘᵢₙ, P_{Max}], the band values Aᵢⱼ obtained from the time series waveform of the vibration in the tire circumferential direction serving as vibration information are corrected by using the tire inner pressure P, and the road surface state is determined by using the corrected hand values Aᵢⱼ(P). Therefore, the determination accuracy of the road surface state can be improved.

In addition, since the determination of the road surface state is stopped in the case where the tire inner pressure P is out of the determinable inner pressure range [Pₘᵢₙ, P_{Max}], erroneous determination of the road surface state can be prevented.

To be noted, although the tire inner pressure is used as the tire state in Embodiment 1, the tire inner temperature may be used as the tire state, or both of the tire inner pressure and the tire inner temperature may be used as the tire state. Alternatively, a tire outer surface temperature may be added to either one or both of the tire inner pressure and the tire inner temperature.

To be noted, the tire inner temperature may be measured by disposing a temperature sensor 19 on the tire air chamber 5 side of a wheel rim 4 or in the inner liner portion 2 of the tire 1 as illustrated in FIG. 2. In addition, the tire outer surface temperature may be measured by, for example, a temperature sensor disposed in a position opposing the tire 1 in a tire house of an unillustrated vehicle body.

In addition, although the band values Aᵢⱼ, which are magnitudes of vibration components of predetermined frequency regions calculated from time series waveforms of the pre-leading region R1, the leading region R2, the pre-trailing region R3, the trailing region R4, and the post-trailing region R5 extracted from a time series waveform, are used as a determination parameter corrected by using the tire state in Embodiment 1 described above, a function value fk of a discriminant function Fk, which is a calculated value calculated from vibration levels of a plurality of predetermined frequency hands, may be used as the determination parameter. Alternatively, wₖ₁ (weight level), which is a coefficient of the discriminant function Fk, or a constant Kₖ may be used as the determination parameter.

The case where the function value fk of the discriminant function Fk is used as the determination parameter corrected by using the tire state corresponds to a first determination step of determining a road surface state by using a determination parameter and state information of the present invention.

In addition, a range of a specific frequency band may be used as the determination parameter.

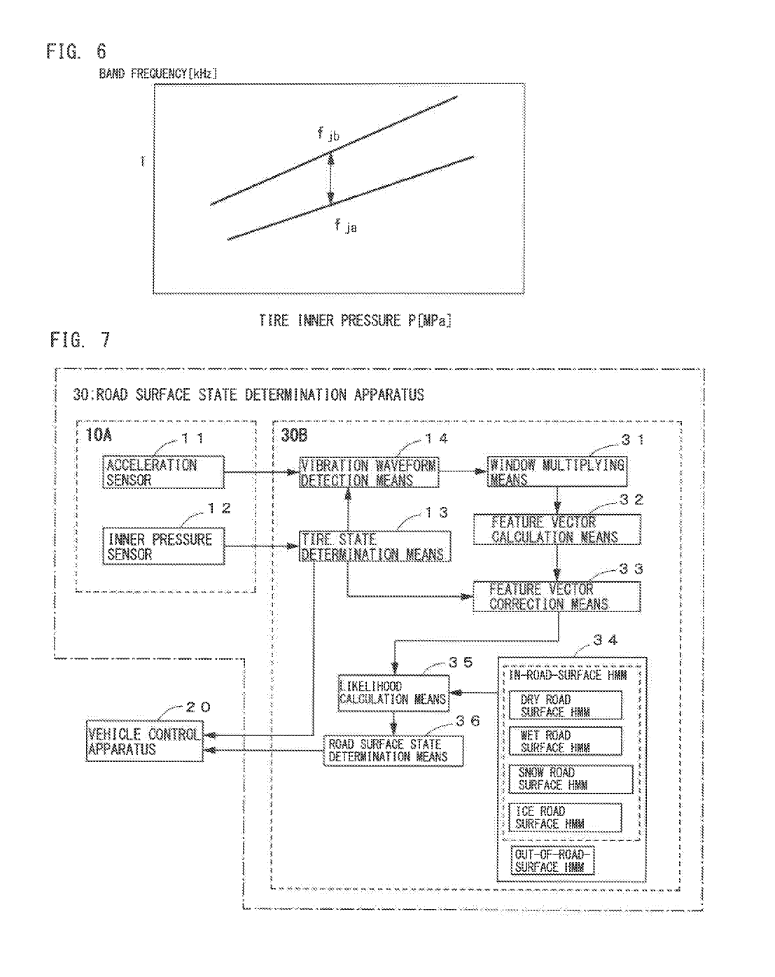

For example, as illustrated in FIG. 6, an upper limit frequency fⱼₐ and a lower limit frequency f_{jb} of a specific frequency region, or a region width (f_{jb}−fⱼₐ) of the specific frequency region changes in accordance with the tire inner pressure P. Therefore, by changing these values in accordance with the tire inner pressure P, the determination accuracy of the road surface state can be improved.

In addition, a time width of a window by which the vibration waveform is to be multiplied may be used as the determination parameter. That is, the position of the peak P_{f} on the leading side and the position of the peak Pₖ on the trailing side of the vibration waveform or also an interval position between the peak P_{f} on the leading side and the peak Pₖ on the trailing side change in accordance with the tire inner pressure and the tire inner temperature. Therefore, by changing the time width of a window to be multiplied by a vibration waveform, which is a region width of the extraction regions (pre-leading region R1, leading region R2, pre-trailing region R3, trailing region R4, and post-trailing region R5) of the vibration waveform, in accordance with tire information, the determination accuracy of the road surface state can be further improved.

In addition, by simultaneously correcting and changing a plurality of determination parameters, the determination accuracy of the road surface state can be further improved.

### Embodiment 2

FIG. 7 is a function block diagram of a road surface state determination apparatus 30 according to Embodiment 2. In this figure, 11 represents an acceleration sensor serving as a vibration detection means, 12 represents an inner pressure sensor serving as a tire state detection means, 13 represents a tire state determination means, 14 represents a vibration waveform detection means, 31 represents a window multiplying means, 32 represents a feature vector calculation means, 33 represents a feature vector correction means, 34 represents a storage means, 35 represents a likelihood calculation means, and 36 represents a road surface state determination means.

The acceleration sensor 11 and the inner pressure sensor 12 constitute a sensor portion 10A, and the tire state determination means 13 means, the vibration waveform detection means 14, and means from the window multiplying means 31 to the road surface state determination means 36 constitute a storage/calculation portion 30B.

Each means constituting the storage/calculation portion 30B is constituted by, for example, software of a computer and a storage device such as a RAM.

To be noted, the acceleration sensor 11, the inner pressure sensor 12, the tire state determination means 13, and the vibration waveform detection means 14 denoted by the same reference signs as in Embodiment 1 are the same as in Embodiment 1, the acceleration sensor 11 detects the vibration in the tire circumferential direction of the tire 1 during travel, and the inner pressure sensor 12 measures the tire inner pressure.

The tire state determination means 13 determines, from data of the measured tire inner pressure, whether or not the measured tire inner pressure P is within the preset determinable inner pressure range [Pₘᵢₙ, P_{Max}], and the vibration waveform detection means 14 detects a time series waveform in which vibration in the tire circumferential direction is arranged in time series as illustrated in FIG. 3.

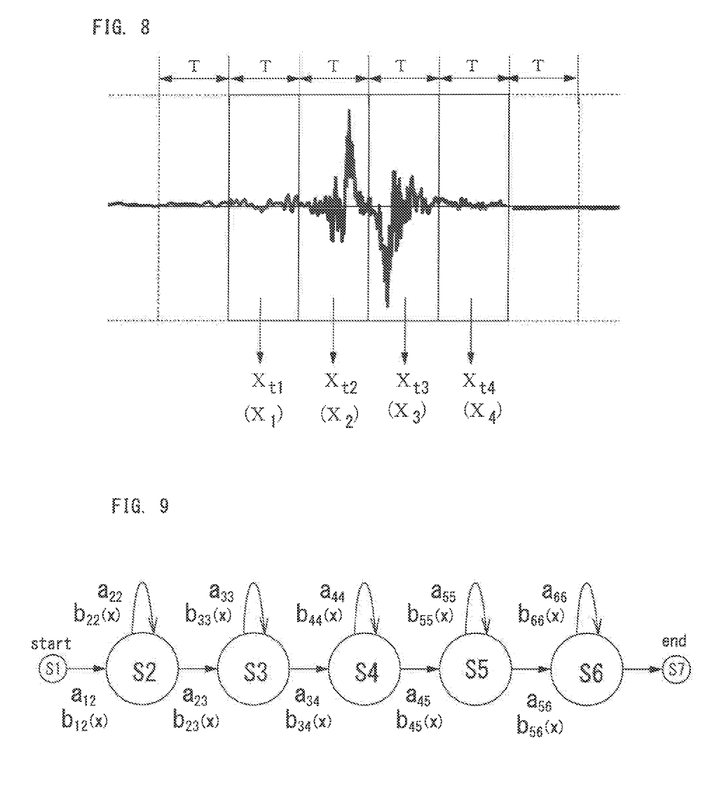

The window multiplying means 31 subjects the time series waveform of the vibration in the tire circumferential direction to window multiplication with a preset time width (time window width), and thus extracts a time series waveform of tire vibration for each time window as illustrated in FIG. 8.

The feature vector calculation means 32 calculates a feature vector Xₜ for each time series waveform extracted for each time window. In this example, as the feature vector Xₜ, vibration levels (power values of filtered waves) xₖₜ of specific frequency bands extracted obtained by filtering each time series waveform of tire vibration by using k band pass filters BP(k) of frequency regions of fₖₐ to f_{kb}. The number of dimensions of a feature vector X is k, and, in this example, since the specific frequency bands are set to six bands of 0 to 0.5 kHz, 0.5 to 1 kHz, 1 to 2 kHz, 2 to 3 kHz, 3 to 4 kHz, and 4 to 5 kHz, k is 6.

Since the feature vector Xₜ is obtained for each time window, when the total number of time windows is N, the number of feature vectors Xₜ is also N.

The feature vector correction means 33 corrects, by using the data of the tire inner pressure P transmitted from the tire state determination means 13, N×k power values xₖₜ (hereinafter referred to as power values xₖₜ) calculated by the feature vector calculation means 32. The method of correction is similar to that of Embodiment 1. That is, a graph indicating a power value ratio a relationship with Kₖ=xₖₜ(P)/xₖₜ(P₀) is prepared, power values xₖₜ of the case where the inner pressure is P are corrected, and corrected feature vectors Xₜ(P) are obtained.

When components of the corrected feature vectors Xₜ(P) are xₖₜ(P), xₖₜ(P)=Kₖ×xₖₜ holds.

The storage means 34 stores a plurality of hidden Markov models (hereinafter referred to as road surface HMMs) constituted for respective road surface states. A road surface HMM is composed of an in-road-surface HMM (road) and an out-of-road-surface HMM (silent). The in-road-surface HMM (road) is constituted by a vibration waveform appearing in a road surface region in the time series waveform of tire vibration, and the out-of-road-surface HMM (silent) is constituted by a waveform in a region without information.

The road surface HMM has seven states S₁ to S₇ corresponding to the time series waveform of tire vibration as illustrated in FIG. 9, and the states S₁ to S₇ are each constituted by two kinds of parameters of emission probabilities bᵢⱼ(X) of the feature vector Xₜ and transition probabilities aᵢⱼ(X) between states (i, j=1 to 7).

In this example, learning of dividing the tire vibration into five states in five states of S₂ to S₆ excluding the start state S₁ and the end state S₇ of each road surface HMM is performed to obtain the emission probabilities bᵢⱼ(X) and the transition states aᵢⱼ(X) between states of the feature vector X of each road surface HMM.

An emission probability bᵢⱼ(X) represents the probability of the feature vector X being output when the state transitions from a state Sᵢ to a state Sⱼ. The emission probability bᵢⱼ(X) is assumed to have a mixed normal distribution.

A transition probability aᵢⱼ(X) represents the probability of the state transitioning from the state Sᵢ to the state Sⱼ.

To be noted, in the case where the number of dimensions of the feature vector X is k, the emission probability bᵢⱼ is set for each of k components xₖ of the feature vector X.

In this example, data of time series waveform obtained in advance by driving a vehicle including the tire 1 provided with the acceleration sensor 11 on respective road surfaces of DRY, WET, SNOW, and ICE is used as learning data, and thus five road surface HMMs composed of four in-road-surface HMMs (road) of a DRY road surface HMM, a WET road surface HMM, a SNOW road surface HMM, and an ICE road surface HMM and one out-of-road-surface HMM (silent) are constructed.

The in-road-surface HMM (road) and the out-of-road-surface HMM (silent) both are HMMs having the seven states of S₁ to S₇ including the start state S₁ and the end state S₇.

The learning of HMM is performed by a known method such as EM algorithm, Baum-Welch algorithm, and forward-backforward algorithm.

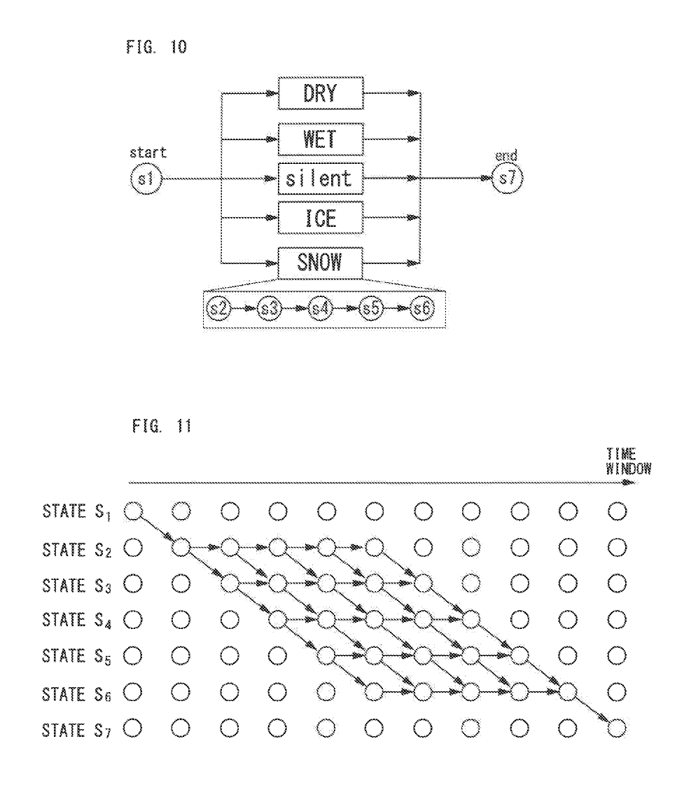

The likelihood calculation means 35 calculates likelihood of a feature vector Xₜ(P) corrected for each of a plurality of (four herein) road surface HMMs as illustrated in FIG. 10.

Regarding the likelihood, as the present applicants have proposed in Japanese Patent Application No. 2011-140943, first, an emission probability P(Xₜ(P)) is calculated for each time window by using the following formulae (1) and (2). To be noted, Xₜ represents a corrected feature vector Xₜ(P) hereinbelow.

$$\begin{matrix}[ Math . 1 ] & \\ P ( {X}_{t} ) = {\prod }_{s = 1}^{S} [ {\sum }_{m = 1}^{Ms} {c}_{jsm} N ( {X}_{st} \vert {μ}_{jsm} , {σ}_{jsm} ) ] & ( 1 ) \\ N ( X \vert μ , σ ) = \frac{1}{\sqrt{{( 2 π )}^{n} \vert σ \vert}} exp \{ - \frac{1}{2} ( x - μ ) {{σ}^{- 1} ( x - μ )}^{T} \} & ( 2 )\end{matrix}$$

X; data series
t; time
S; number of states
Mₛ; number of components in mixed Gauss distribution
cⱼₛₘ; mixture ratio of m-th mixture component
μ; average vector of Gauss distribution
σ; variance-covariance matrix of Gauss distribution

Since the road surface HMM has 7 states, a transition probability π(Xₜ) can be represented by a 7×7 matrix. As this transition probability π(Xₜ), the transition probability aᵢⱼ(Xₜ) between states of the feature vector Xₜ obtained by learning of the road surface HMM described above can be used.

Then, an appearance probability K(Xₜ) for each time window, which is a product of the calculated emission probability P(Xₜ) and the transition probability π(Xₜ) is obtained, and a likelihood Z is obtained by multiplying the appearance probability K(Xₜ) for each time window for all time windows. That is, the likelihood Z is obtained by Z=ΠP(Xₜ)·transition probability π(Xₜ). Alternatively, the likelihood Z may be obtained by calculating a log of the appearance probability K(Xₜ) calculated for each time window and adding the log for all time windows.

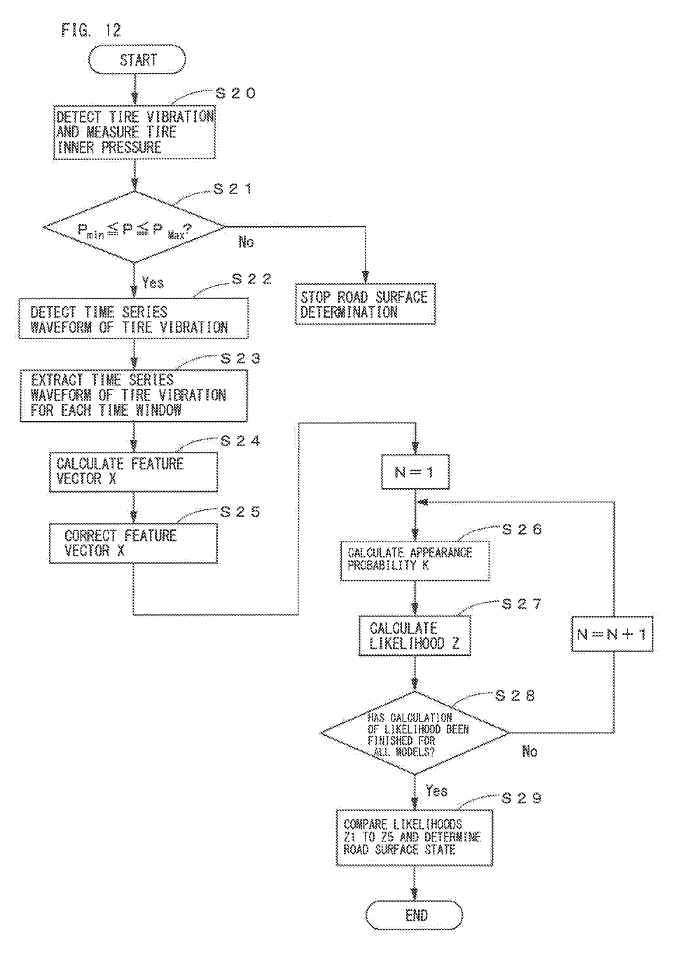

Incidentally, there are a plurality of paths (state transition series) through which the state of the road surface HMM transitions from the state S₁ to the state S₇ as illustrated in FIG. 11. That is, the likelihood Z is different between state transition series for each road surface HMM.

In this example, a state transition series Z_{M} with the highest likelihood Z is obtained by applying a known Viterbi algorithm, this state transition series is set as a state transition series corresponding to the detected time series waveform of tire vibration, and the likelihood Z_{M} is set as Z of the road surface HMM.

The likelihood Z_{M} is obtained for each road surface HMM.

The road surface state determination means 36 compares respective likelihoods of a plurality of hidden Markov models calculated by the likelihood calculation means 35, and determines a road surface state corresponding to a hidden Markov model with the highest likelihood as the road surface state of a road surface on which the tire is traveling.

Next, a determination method of road surface state according to Embodiment 2 will be described with reference to a flowchart of FIG. 12.

First, the acceleration sensor 11 detects the vibration of the tire 1 in the tire circumferential direction during travel, and the inner pressure sensor 12 measures the tire inner pressure (step S20).

Next, whether or not the measured tire inner pressure P is within the preset determinable inner pressure range [Pₘᵢₙ, P_{Max}] is determined from the data of the measured tire inner pressure P (step S21).

In the case where the tire inner pressure P is within the determinable inner pressure range [Pₘᵢₙ, P_{Max}], the process proceeds to step S22, a time series waveform in which the vibration in the tire circumferential direction, which is the output of the acceleration sensor 11, is arranged in time series is detected, then the time series waveform that is data of tire vibration is subjected to window multiplication by a preset time window, and thus a time series waveform of tire vibration for each time window is extracted (step S23).

In this example, the time window width is set to 2 msec.

In contrast, in the case where the measured tire inner pressure P is P<Pₘᵢₙ or P>P_{Max}, the extraction of time series waveform of tire vibration is stopped. To be noted, whether the measured tire inner pressure P is within the determinable inner pressure range [Pₘᵢₙ, P_{Max}] may be determined again after a predetermined time has elapsed.

In step S24, the feature vector Xₜ=(x₁ₜ, x₂ₜ, x₃ₜ, x₄ₜ, x₅ₜ, x₆ₜ) is calculated for each time series waveform extracted for each time window.

In the present invention, the power values x₁ₜ to x₆ₜ of filtered waves of the time series waveform of tire vibration, which are components of the calculated feature vector Xₜ, are corrected by using the data of the tire inner pressure P (step S25). To be noted, this correction is performed for each power value xₖₜ (k=1 to 6).

After correcting the power values xₖₜ, first, the appearance probability K(Xₜ)=emission probability P(Xₜ)×transition probability π(Xₜ) is obtained for each time window for the DRY road surface HMM serving as the first road surface HMM (step S26), and a likelihood Z1 of the DRY road surface HMM is calculated by multiplying the appearance probability K(Xₜ) for all time windows (step S27).

Next, whether or not the calculation of the likelihood Z has been finished for all the models is determined (step S28), and in the case where the calculation is not finished, the process returns to step S26, and a likelihood Z2 of the WET road surface HMM, which is the next model, is calculated.

In the case where the calculation of the likelihood Z for all the five models has been finished, the process proceeds to step S29, and the road surface state is determined. Specifically, likelihoods Z1 to Z5 calculated for respective road surface HMMs are compared, and a road surface state corresponding to a road surface HMM with the highest likelihood is determined as the road surface state of the road surface on which the tire is traveling.

As described above, in Embodiment 2, the vibration in the tire circumferential direction of the tire 1 during travel is detected by the acceleration sensor 11, the tire inner pressure P is measured by the inner pressure sensor 12, and in the case where the measured tire inner pressure P is within the determinable inner pressure range [Pₘᵢₙ, P_{Max}], the power values xₖₜ of filtered waves, which are components of the feature vector Xₜ calculated from the time series waveform of tire vibration extracted for each time window by window multiplication by the window multiplying means 31 are corrected by using the data of the tire inner pressure P, and then the road surface state is determined by using the feature vector Xₜ(P) including the corrected power values xₖₜ(P) of filtered waves as components. Therefore, the determination accuracy of the road surface state can be improved.

In addition, since the determination of the road surface state is stopped in the case where the tire inner pressure P is out of the determinable inner pressure range [Pₘᵢₙ, P_{Max}], erroneous determination of the road surface state can be prevented.

To be noted, although the power values xₖₜ of filtered waves, which are components of the feature vector Xₜ of the time series waveform extracted for each time window, is used as the determination parameter corrected by using the tire state in Embodiment 2 described above, the magnitude of the likelihood Z serving as a determination function may be used as the determination parameter. Alternatively, weight vectors of determination functions of the emission probability P(Xₜ) and the transition probability π(Xₜ) of the feature vector X of each road surface HMM, the number S of states, the number Mₛ of components in mixed Gauss distribution, the mixture ratio cⱼₛₘ of m-th mixture component, the average vector μ of Gauss distribution, variance-covariance matrix σ of Gauss distribution, and the like, or intermediate parameters of the weight vectors may be used as the determination parameter.

The case where the magnitude of the likelihood Z is used as the determination parameter corrected by using the tire state corresponds to a first determination step of determining a road surface state from the determination parameter and the state information of the present invention.

Parameters such as the emission probability P(Xₜ) and the transition probability π(Xₜ) corrected by using the tire inner pressure P are obtained by learning of the road surface HMM.

In addition, since appropriate values of frequency regions fₖₐ−f_{kb} of the band pass filters BP(k) when obtaining the power values xₖₜ change in accordance with the tire inner pressure P, by using these values as the determination parameter changed in accordance with the tire inner pressure P, the determination accuracy of the road surface state can be improved.

In addition, the time window width may be used as the determination parameter. By changing the time width of window multiplication (time window width) of the time series waveform of the vibration in the tire circumferential direction like, for example, setting a wider time window width in the case where the tire inner pressure P is high, the determination accuracy of the road surface state can be improved.

In addition, by simultaneously correcting and changing the plurality of determination parameters, the determination accuracy of the road surface state can be further improved.

### Embodiment 3

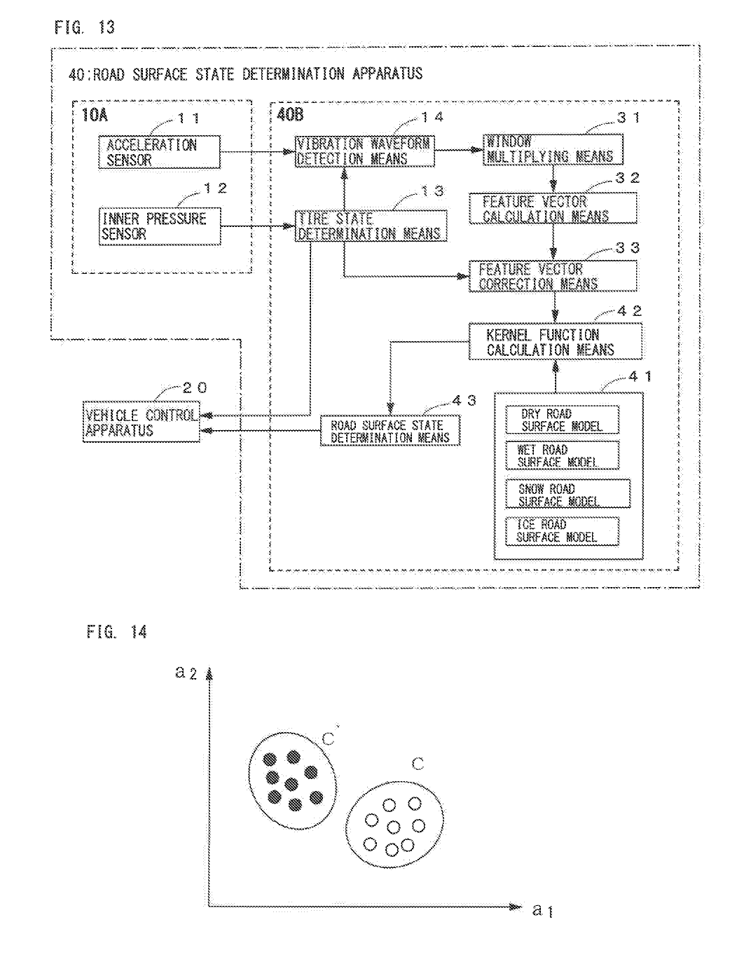

FIG. 13 is a function block diagram of a road surface state determination apparatus 40 according to Embodiment 3. In this figure, 11 represents an acceleration sensor serving as a vibration detection means, 12 represents an inner pressure sensor serving as a tire state detection means, 13 represents a tire state determination means, 14 represents a vibration waveform detection means, 31 represents a window multiplying means, 32 represents a feature vector calculation means, 33 represents a feature vector correction means, 41 represents a storage means, 42 represents a kernel function calculation means, and 43 represents a road surface state determination means.

The acceleration sensor 11 and the inner pressure sensor 12 constitute a sensor portion 10A, and the tire state determination means 13 means, the vibration waveform detection means 14, and means from the window multiplying means 31 to the road surface state determination means 43 constitute a storage/calculation portion 40B.

Each means constituting the storage/calculation portion 40B is constituted by, for example, software of a computer and a storage device such as a RAM.

To be noted, the acceleration sensor 11, the inner pressure sensor 12, the tire state determination means 13, the vibration waveform detection means 14, and means from the window multiplying means to the feature vector correction means 33 denoted by the same reference signs as in Embodiments 1 and 2 are the same as in Embodiments 1 and 2, the acceleration sensor 11 detects the vibration in the tire circumferential direction of the tire 1 during travel, and the inner pressure sensor 12 measures the tire inner pressure.

In addition, the tire state determination means 13 determines, from data of the measured tire inner pressure, whether or not the measured tire inner pressure P is within the preset determinable inner pressure range [Pₘᵢₙ, P_{Max}], and the vibration waveform detection means 14 detects a time series waveform in which vibration in the tire circumferential direction is arranged in time series.

The window multiplying means 31 subjects the time series waveform of the vibration in the tire circumferential direction to window multiplication with a preset time width (time window width), and thus extracts a time series waveform of tire vibration for each time window as illustrated in FIG. 8.

The feature vector calculation means 32 calculates a feature vector Xₜ for each time series waveform extracted for each time window.

In this example, as the feature vector Xₜ, vibration levels (power values of a filtered wave) xₖₜ (k=1 to 6) of specific frequency bands respectively obtained by filtering each time series waveform of tire vibration by using band pass filters of 0 to 1 kHz, 1 to 2 kHz, 2 to 3 kHz, 3 to 4 kHz, and 4 to 5 kHz are used.

Since the feature vector Xₜ is obtained for each time window, when the total number of time windows is N, the number of feature vectors Xₜ is also N. Hereinafter, a feature vector whose window number is i will be described as Xᵢ, and power values that are components of Xᵢ will be described as xₖᵢ.

The feature vector correction means 33 corrects, by using the data of the tire inner pressure P transmitted from the tire state determination means 13, N×k power values xₖᵢ calculated by the feature vector calculation means 32, and thus obtains corrected feature vectors Xᵢ(P).

The method of correction is similar to that of Embodiment 1. That is, a graph indicating a power value ratio a relationship with Kₖ=xₖᵢ(P)/xₖᵢ(P₀) is prepared, and the power values xₖᵢ of the case where the inner pressure P are corrected.

Components xₖᵢ(P) of the corrected feature vectors Xᵢ(P) are xₖᵢ(P)=Kₖ×xₖᵢ.

FIG. 14 is a schematic diagram illustrating an input space of the feature vector Xᵢ, in which each axis represents a vibration level aᵢₖ of a specific frequency band, which is a feature value, and each point represents a feature vector Xᵢ. Although the actual input space is a seven-dimensional space in total with the time axis because the number of specific frequency bands is 6, this figure is illustrated in two dimensions (the horizontal axis represents a₁ and the vertical axis represents a₂).

For example, assuming that the vehicle is driving on a DRY road surface, if points composing a group C can be distinguished from a group C′ composed of feature vectors X′ᵢ calculated when the vehicle is driving on a SNOW road surface, whether the vehicle is driving on a DRY road surface or on a SNOW road surface can be determined.

The storage means 41 stores four road surface models for separating a DRY road surface from the other road surfaces, a WET road surface from the other road surfaces, a SNOW road surface from the other road surfaces, and an ICE road surface from the other road surfaces by a discriminant function f(x) representing a separating hyperplane.

The road surface models are obtained by learning by using, as input data, a road surface feature vector Y_{ASV}(yⱼₖ), which is a feature vector for each time window calculated from a time series waveform of tire vibration obtained by driving a test car including a tire to which an acceleration sensor is attached on respective road surfaces of DRY, WET, SNOW, and ICE at various speeds.

To be noted, only one kind of tire size may be used for the learning, or a plurality of kinds of tire sizes may be used for the learning.

The suffix A of the road surface feature vector Y_{ASV}(yⱼₖ) represents DRY, WET, SNOW, and ICE. The suffix j (j=1 to M) represents the number of time series waveforms (window number) extracted by time windows, and the suffix k indicates a component of a vector. That is, yⱼₖ=(aⱼ₁, aⱼ₂, aⱼ₃, aⱼ₄, aⱼ₅, aⱼ₆) holds. In addition, SV is an abbreviation of support vector, and represents data in the vicinity of a decision boundary selected by the learning.

Hereinafter, the road surface feature vector Y_{ASV}(yⱼₖ) will be simply described as Y_{ASV}.

The calculation method for each road surface feature vector Y_{ASV} is similar to that of the feature vector Xⱼ described above. For example, in the case of a DRY road surface feature vector Y_{DSV}, a time series waveform of tire vibration when driving on a DRY road surface is subjected to window multiplication with a time width T, a time series waveform of tire vibration is extracted for each time window, and a DRY road surface feature vector Y_{D} is calculated for each time series waveform extracted for each time window. To be noted, the number of dimensions of a vector yᵢ of the DRY road surface feature vector Y_{D} is 6 similarly to the feature vector Xᵢ. Then, by performing learning by a support vector machine (SVM) by using Y_{D} as learning data, a support vector Y_{DSV} is selected. To be noted, the storage means 41 does not have to store all Y_{D}, and only the selected Y_{DSV} described above may be stored.

A WET road surface feature vector Y_{WSV}, a SNOW road surface feature vector Y_{SSV}, and an ICE road surface feature vector Y_{ISV} can be obtained in a similar manner to the DRY road surface feature vector Y_{DSV}.

Here, it is important that the time width T is the same value as the time width T of the case of obtaining the feature vector Xⱼ. In the case where the time width T is constant, the number M of time series waveforms of time windows varies depending on the kind of tire and the vehicle speed. That is, the number M of time series waveforms of time windows of the road surface feature vector YASV does not necessarily coincide with the number N of time series waveforms of time windows of the feature vector Xⱼ. For example, even in the case where the kind of tire is the same. M>N holds when the vehicle speed at the time of obtaining the feature vector Xⱼ is lower than the vehicle speed at the time of obtaining the DRY road surface feature vector Y_{DSV}, and M<N holds when the former is higher than the latter.

The road surface model can be constructed by SVM by using respective road surface feature vectors Y_{A} as learning data as proposed by the present applicants in Japanese Patent Application No. 2012-176779.

FIG. 15 is a conceptual diagram illustrating a DRY road surface feature vector Y_{DSV} and a road surface feature vector Y_{nDSV} not of a DRY road surface in an input space, and in this figure, black dots represent road surface feature vectors of DRY road surfaces, and dots of a lighter color represent road surface feature vectors not of a DRY surface.

To be noted, although both the DRY road surface feature vector and the road surface feature vector not of a DRY road surface are matrices, the DRY road surface feature vector and the road surface feature vector not of a DRY road surface are each represented as a two-dimensional vector in FIG. 14 for explaining how a group decision boundary is obtained.

Generally, linear separation cannot be performed at a group decision boundary. Therefore, nonlinear classification is performed on road surface feature vectors Y_{DSV} and Y_{nDSV} in the original input space by mapping the road surface feature vectors Y_{DSV} and Y_{nDSV} in a feature space of a higher dimension by nonlinear mapping φ by using a kernel method.

Specifically, a discriminant function f(x)=w^{T}φ(x)−b most suitable for identifying data is obtained by using a data set X=(x₁, x₂, . . . xₙ) and a belonging class z=(1, −1). Here, the data is the road surface feature vectors Y_{Dj} and Y_{nDj}, a belonging class z=1 indicates data of a DRY road surface indicated by χ₁ in the figure, and z=−1 indicates data of a road surface different from a DRY road surface indicated by χ₂. In addition, w is a weight coefficient, b is a constant, and f(x)=0 corresponds to the decision boundary.

The discriminant function f(x)=w^{T}φ(x)−b is optimized by using, for example, a method of Lagrange multiplier. The optimization problem can be replaced by the following formulae (3) and (4).

$$\begin{matrix}[ Math . 2 ] & \\ \begin{matrix}maximize & {\sum }_{α}^{ } {λ}_{α} - \frac{1}{2} {\sum }_{α : β}^{ } {λ}_{α} {λ}_{β} {z}_{α} {z}_{β} φ ( {x}_{α} ) φ ( {x}_{β} )\end{matrix} & ( 3 ) \\ \begin{matrix}subject to & {\sum }_{α}^{ } {λ}_{α} {z}_{α} = 0 , {λ}_{α} > 0\end{matrix} & ( 4 )\end{matrix}$$

Here, α and β are indices of a plurality of pieces of learning data. In addition, λ is a Lagrange multiplier which satisfies λ>0.

In this case, the discriminant function f(x)=w^{T}φ(x)−b can be non-linearized by replacing an inner product φ(x_{α})φ(x_{β}) by a kernel function K(x_{α}, x_{β}). To be noted, φ(x_{α})φ(x_{β}) is an inner product after mapping x_{α} and x_{β} in a high-dimension space by mapping φ.

The Lagrange multiplier λ can be obtained by using an optimization algorithm such as a gradient descent method or sequential minimal optimization (SMO) on the formula (2) described above. In this case, since a kernel function is used, the high-dimension inner product does not have to be directly obtained. Therefore, the calculation time can be greatly reduced.

In this example, a global alignment kernel function (GA kernel) is used as the kernel function K(x_{α}, x_{β}). The GA kernel K(x_{α}, x_{β}) is a function constituted by the sum or the product of all local kernels κᵢⱼ(xᵢ, xⱼ) representing a degree of similarity between the DRY road surface feature vector xᵢ=Y_{Di} and the road surface feature vector x, =Y_{nDj} not of a DRY road surface as shown in FIG. 16 and the following formulae (5) and (6), and can directly compare time series waveforms of different time lengths.

The local kernel κᵢⱼ(xᵢ, xⱼ) is obtained for each window at a time interval T.

To distinguish the DRY road surface and the road surface different from the DRY road surface, the DRY road surface and the road surface different from the DRY road surface can be distinguished from each other with a high accuracy by providing a margin to the discriminant function f(x), which is a separating hyperplane that separates the DRY road surface feature vector Y_{Dj} and the road surface feature vector Y_{nDj} not of the DRY road surface.

The margin refers to a distance from the separating hyperplane to the closest sample (support vector), the separating hyperplane, which is the decision boundary, is f(x)=0. All the DRY road surface feature vectors Y_{Dj} are in a region of f(x)≥+1, and the road surface feature vectors Y_{nDj} not of the DRY road surface are in a region of f(x)≤−1.

The DRY road surface model that distinguishes the DRY road surface from the other road surfaces is an input space including a support vector Y_{DSV} in a distance of f(x)=+1 and a support vector Y_{nDSV} in a distance of f(x)=−1. Generally, Y_{DSV} and Y_{nDSV} described above are present in plural numbers.

The same applies to a WET model that distinguishes the WET road surface from the other road surfaces, a SNOW model that distinguishes the SNOW road surface from the other road surfaces, and an ICE model that distinguishes the ICE road surface from the other road surfaces.

In this example, a global alignment kernel function (GA kernel) is used as the kernel function K(x_{α}, x_{β}). The GA kernel K(x_{α}, x_{β}) is a function constituted by the sum or the product of all local kernels κᵢⱼ(xᵢ, xⱼ) representing a degree of similarity between the DRY road surface feature vector xᵢ=Y_{Di} and the road surface feature vector xⱼ=Y_{nDj} not of a DRY road surface as shown in FIG. 7 and the following formulae (5) and (6), and can directly compare time series waveforms of different time lengths.

$$\begin{matrix}[ Math . 3 ] & \\ K ( {x}_{α} , {x}_{β} ) = {\sum }_{i = 1}^{m} {\sum }_{j = 1}^{n} {κ}_{ij} ( {x}_{α i} , {x}_{β j} ) & ( 5 ) \\ {κ}_{ij} ( {x}_{α i} , {x}_{β j} ) = exp ( - \frac{{‖ {x}_{α i} , {x}_{β j} ‖}^{2}}{{σ}^{2}} ) & ( 6 )\end{matrix}$$

wherein ∥x_{αi}−x_{βi}∥ is a distance (norm) between feature vectors, and σ is a constant.

The local kernel κᵢⱼ(xᵢ, xⱼ) is obtained for each window of a time interval T.

To be noted, FIG. 17 illustrates an example in which a GA kernel of the DRY road surface feature vector Y_{Dj} whose number of time windows is 6 and the road surface feature vector Y_{nDj} not of a DRY road surface whose number of time windows is 4 is obtained.

To distinguish the DRY road surface and the road surface different from the DRY road surface, the DRY road surface and the road surface different from the DRY road surface can be distinguished from each other with a high accuracy by providing a margin to the discriminant function f(x), which is a separating hyperplane that separates the DRY road surface feature vector Y_{Dj} and the road surface feature vector Y_{nDj} not of the DRY road surface.

The margin refers to a distance from the separating hyperplane to the closest sample (support vector), the separating hyperplane, which is the decision boundary, is f(x)=0. All the DRY road surface feature vectors Y_{Dj} are in a region of f(x)≥+1, and the road surface feature vectors Y_{nDj} not of the DRY road surface are in a region of f(x)≤−1.

The DRY road surface model that distinguishes the DRY road surface from the other road surfaces is an input space including a support vector Y_{DSV} in a distance of f(x)=+1 and a support vector Y_{nDSV} in a distance of f(x)=−1. Generally, Y_{DSV} and Y_{nDSV} described above are present in plural numbers.

The same applies to a WET model that distinguishes the WET road surface from the other road surfaces, a SNOW model that distinguishes the SNOW road surface from the other road surfaces, and an ICE model that distinguishes the ICE road surface from the other road surfaces.

The kernel function calculation means 42 respectively calculates GA kernels K_{D}(X, Y), K_{W}(X, Y), K_{S}(X, Y), and K_{I}(X, Y) from the feature vector Xᵢ(P) calculated by the feature vector calculation means 32 and corrected by the feature vector correction means 33, and from respective support vectors Y_{ASV} and Y_{nASV} (A=D, W, S, and I) of the DRY model, the WET model, the SNOW model, and the ICE model stored in the storage means 41.

As illustrated in FIG. 17, the GA kernel K(X, Y) is a function constituted by the sum or the product of all local kernels κᵢⱼ(Xᵢ, Yⱼ) when xᵢ is the feature vector Xᵢ and xⱼ is the road surface vector Y_{Aj} or Y_{nAj} in [Math. 3] described above, and can directly compare time series waveforms of different time lengths. To be noted, this figure illustrates an example in which xⱼ is the road surface feature vector Y_{Aj}, the number of time windows of the feature vector Xᵢ is n=5, and the number of time windows of the road surface feature vector Y_{Aj} is m=4.

As in this example, the degree of similarity between feature vectors Xᵢ and Y_{Aj} (or between Xᵢ and Y_{nAj}) can be obtained even in the case where the number n of time series waveforms of time windows in the case of obtaining the feature vector Xᵢ and the number m of time series waveforms of time windows in the case of obtaining the road surface feature vector Y_{Aj} (or Y_{nAj}) are different.

The road surface state determination means 43 determines the road surface state on the basis of values of four discriminant functions f_{A}(x) (A=D, W, S, and I) using kernel functions K_{A}(X, Y) shown in the following formulae (7) to (10).

$$\begin{matrix}[ Math . 4 ] & \\ {f}_{D} = {\sum }_{α = 1}^{{N}_{DSV}} {λ}_{{D}_{α}} {z}_{{D}_{α}} {K}_{D} ( X , {Y}_{α} ) - {b}_{D} & ( 7 ) \\ {f}_{W} = {\sum }_{α = 1}^{{N}_{WSV}} {λ}_{{W}_{α}} {z}_{{W}_{α}} {K}_{W} ( X , {Y}_{α} ) - {b}_{W} & ( 8 ) \\ {f}_{S} = {\sum }_{α = 1}^{{N}_{SSV}} {λ}_{{S}_{α}} {z}_{{S}_{α}} {K}_{S} ( X , {Y}_{α} ) - {b}_{S} & ( 9 ) \\ {f}_{I} = {\sum }_{α = 1}^{{N}_{ISV}} {λ}_{{I}_{α}} {z}_{{I}_{α}} {K}_{I} ( X , {Y}_{α} ) - {b}_{I} & ( 10 )\end{matrix}$$

f_{D} is a discriminant function for distinguishing the DRY road surface from the other road surfaces, f_{W} is a discriminant function for distinguishing the WET road surface from the other road surfaces, f_{S} is a discriminant function for distinguishing the SNOW road surface from the other road surfaces, and f_{I} is a discriminant function for distinguishing the ICE road surface from the other road surfaces.

In addition, N_{DSV} is the number of support vectors of the DRY model, N_{WSV} is the number of support vectors of the WET model, N_{SSV} is the number of support vectors of the SNOW model, and N_{ISV} is the number of support vectors of the ICE model.

In this example, the discriminant functions f_{D}, f_{W}, f_{S}, and f_{I} are respectively calculated, and the road surface state is determined from the discriminant function indicating the largest value among the calculated discriminant functions f_{A}.

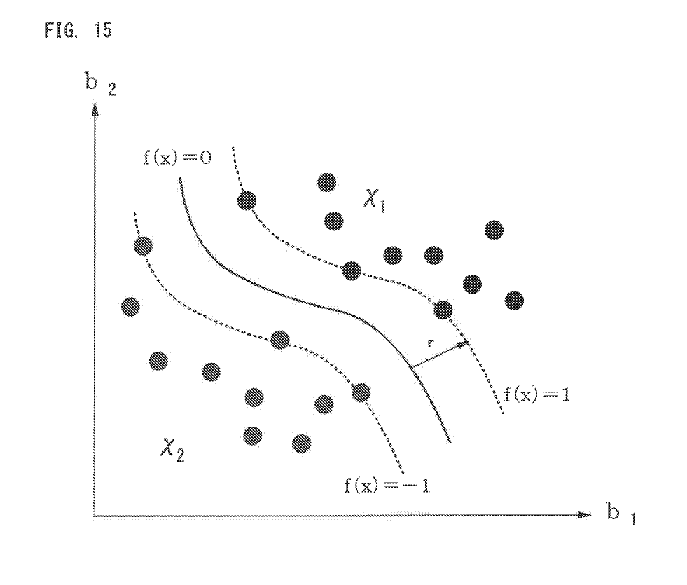

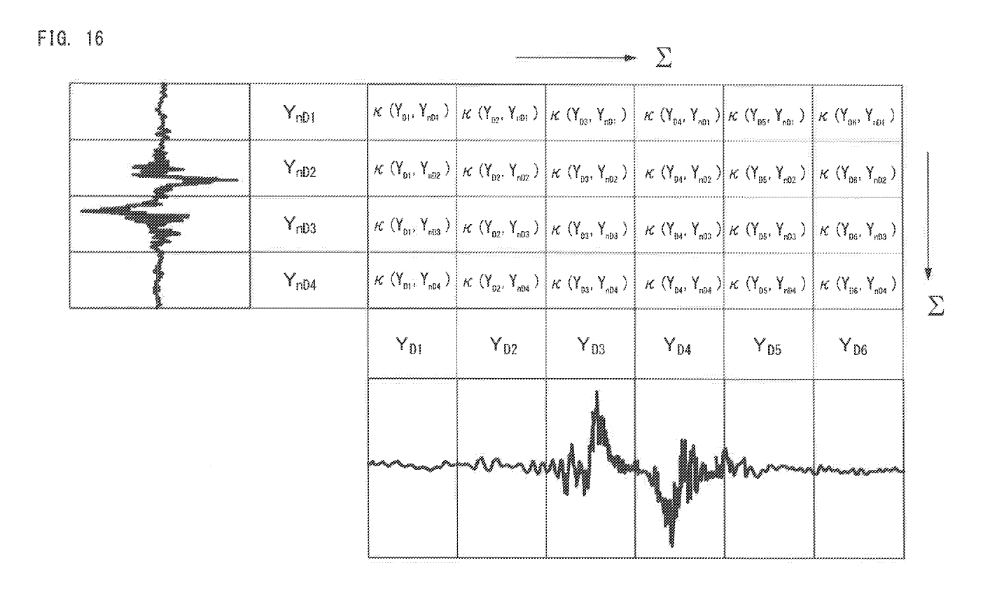

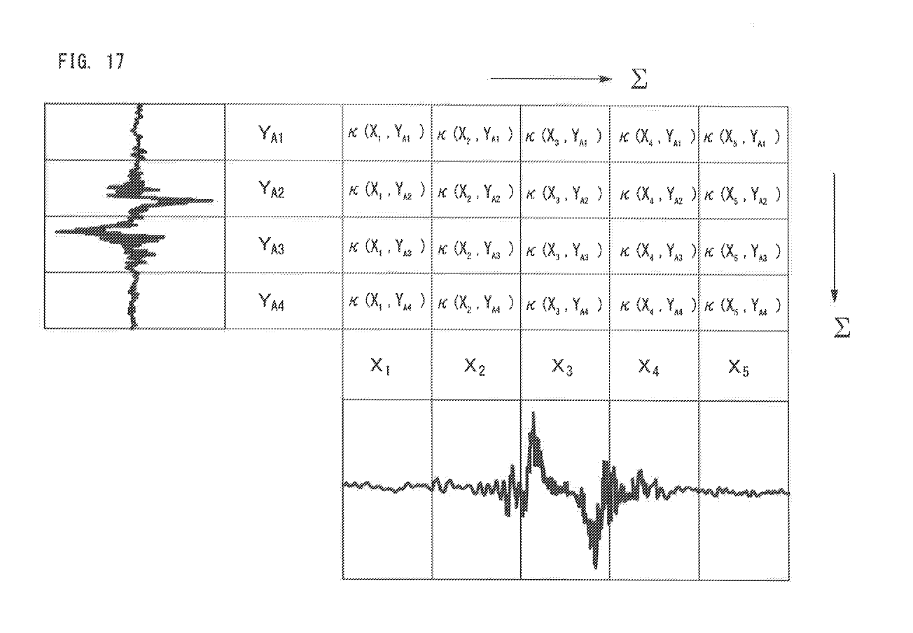

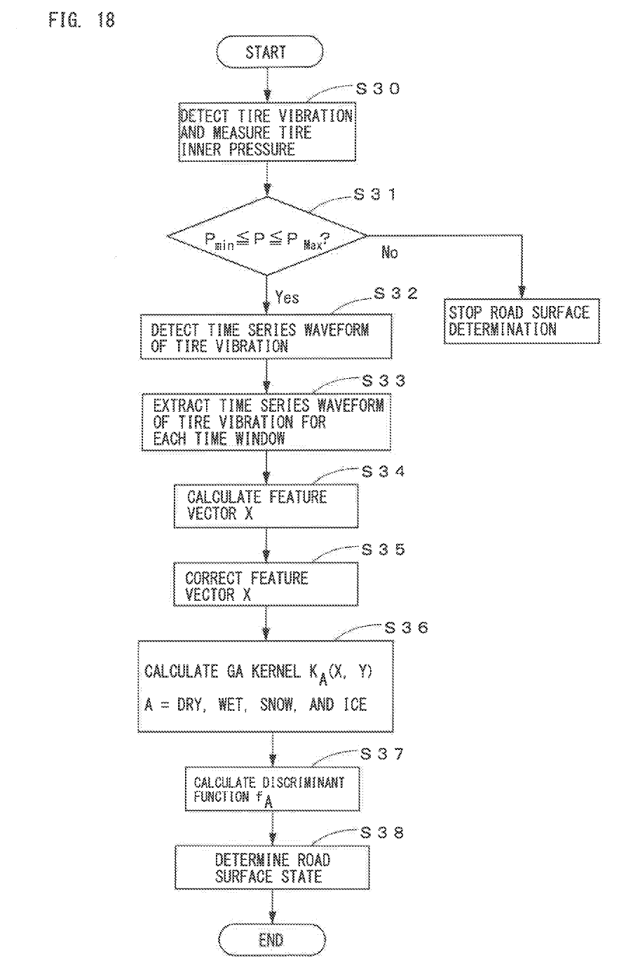

Next, a determination method of the road surface state according to Embodiment 3 will be described with reference to a flowchart of FIG. 18.

First, the acceleration sensor 11 detects the vibration of the tire 1 in the tire circumferential direction during travel, and the inner pressure sensor 12 measures the tire inner pressure (step S30).

Next, whether or not the measured tire inner pressure P is within the preset determinable inner pressure range [Pₘᵢₙ, P_{Max}] is determined from the data of the measured tire inner pressure (step S31).

In the case where the tire inner pressure P is within the determinable inner pressure range [Pₘᵢₙ, P_{Max}], the process proceeds to step S32, a time series waveform in which the vibration in the tire circumferential direction, which is the output of the acceleration sensor 11, is arranged in time series is detected, then the time series waveform that is data of tire vibration is subjected to window multiplication by a preset time window, and thus a time series waveform of tire vibration for each time window is extracted (step S33). The number of time series waveforms of tire vibration for respective time windows is m.

In contrast, in the case where the measured tire inner pressure P is P<Pₘᵢₙ or P>P_{Max}, the extraction of time series waveform of tire vibration is stopped. To be noted, whether the measured tire inner pressure P is within the determinable inner pressure range [Pₘᵢₙ, P_{Max}] may be determined again after a predetermined time has elapsed.

In step S34, the feature vector Xᵢ=(xᵢ₁, xᵢ₂, xᵢ₃, xᵢ₄, xᵢ₅, xᵢ₆) is calculated for each time series waveform extracted for each time window.

In the present invention, the power values x₁ᵢ to x₆ᵢ of filtered waves of the time series waveform of tire vibration, which are components of the calculated feature vector Xₜ are corrected by using the data of the tire inner pressure P (step S35). To be noted, this correction is performed for each power value xₖᵢ (k=1 to 6).

Next, the local kernels κᵢⱼ(Xᵢ, Yⱼ) are calculated from the corrected feature vector Xᵢ(P) and the support vector Y_{Ak} of the road surface model stored in the storage means 41, then the sum of all the local kernels κᵢⱼ(Xᵢ, Yⱼ) is obtained, and global alignment kernel functions K_{D}(X, Y), K_{W}(X, Y), K_{S}(X, Y), and K_{I}(X, Y) are respectively calculated (step S36).

Next, four discriminant functions f_{D}(x), f_{W}(x), f_{S}(x), and f_{I}(x) using the kernel functions K_{A}(X, Y) are respectively calculated (step S37), then the values of the calculated discriminant functions f_{A}(X) are compared, and the road surface state of the discriminant function indicating the largest value is determined as the road surface state of the road surface on which the tire 1 is traveling (step S38).

To be noted, although the power values xₖₜ of filtered waves, which are components of the feature vector Xₜ of the time series waveform extracted for each time window, is used as the determination parameter corrected by using the tire state in Embodiment 3 described above, output values of the discriminant functions f_{D}, f_{W}, f_{S}, and f_{I} may be used as the determination parameter.

The case where the magnitude of the likelihood Z is used as the determination parameter corrected by using the tire state corresponds to a first determination step of determining a road surface state from the determination parameter and the state information of the present invention.

Alternatively, the belonging class z and the local kernels κᵢⱼ(Xᵢ, Yⱼ), which are parameters for obtaining the weight w of the discriminant function f(x), or the constant σ for calculating the local kernels κᵢⱼ(Xᵢ, Yⱼ) may be used as the determination parameter.

In addition, the kernel function o be used may be changed in accordance with the tire inner pressure P like, for example, changing the kernel function K to a dynamic time-warping kernel function (DTW kernel).

Alternatively, a parameter necessary for a learning process of a support vector machine may be used as the determination parameter.

In addition, the extraction method of the vibration information may be changed instead of changing the vibration information.

That is, also in this Embodiment 3, similarly to Embodiment 2 described above, the determination accuracy of the road surface state can be also improved by using the appropriate values of frequency regions fₖₐ−f_{kb} of the band pass filters BP(k) when obtaining the power values xₖₜ or the time width (time window width) for window multiplication of the time series waveform of the vibration in the tire circumferential direction as the determination parameter changed in accordance with the tire information.

In addition, by simultaneously correcting and changing the plurality of determination parameters, the determination accuracy of the road surface state can be further improved.

In addition, although the tire inner pressure is used as the tire state also in Embodiments 2 and 3, the tire inner temperature may be used as the tire state similarly to Embodiment 1 described above, or both of the tire inner pressure and the tire inner temperature may be used as the tire state. Alternatively, a tire outer surface temperature may be added to either one or both of the tire inner pressure and the tire inner temperature.

### Embodiment 4

FIG. 19 is a function block diagram of a road surface state determination apparatus 110 according to the present embodiment. In this figure, 111 represents an acceleration sensor serving as a vibration detection means, 112 represents a braking/driving force estimating means that estimates a braking/driving force serving as external information input to the tire, 113 represents a braking/driving force determination means, 114 represents a vibration waveform detection means, 115 represents a region signal detection means, 116 represents a band value calculation means, 117 represents a band value correction means, and 118 represents a road surface state determination means.

Each means from the braking/driving force determination means 113 to the road surface state determination means 118 is constituted by, for example, software of a computer and a storage device such as a RAM, and is provided on the unillustrated vehicle body side.

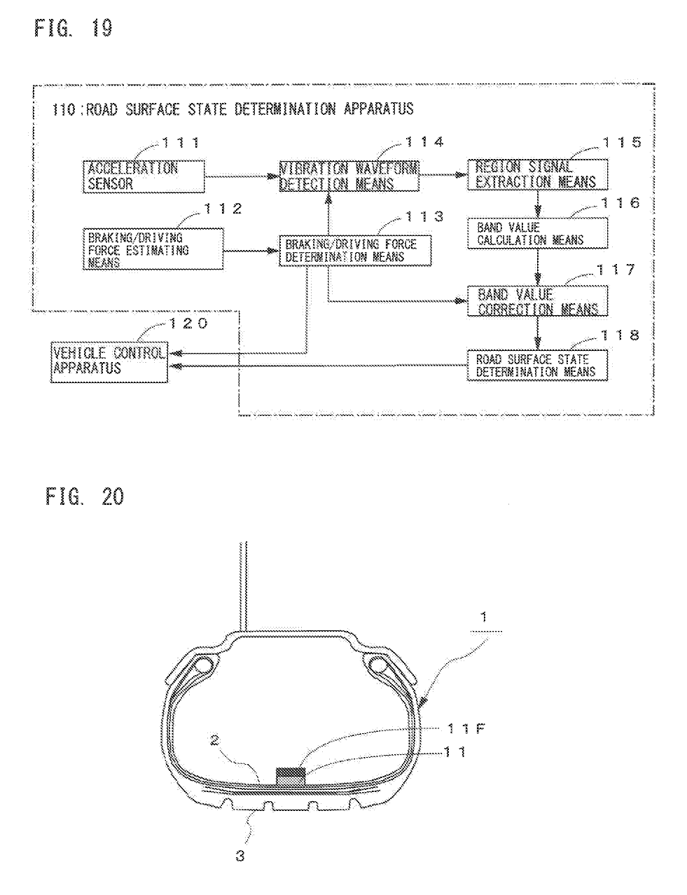

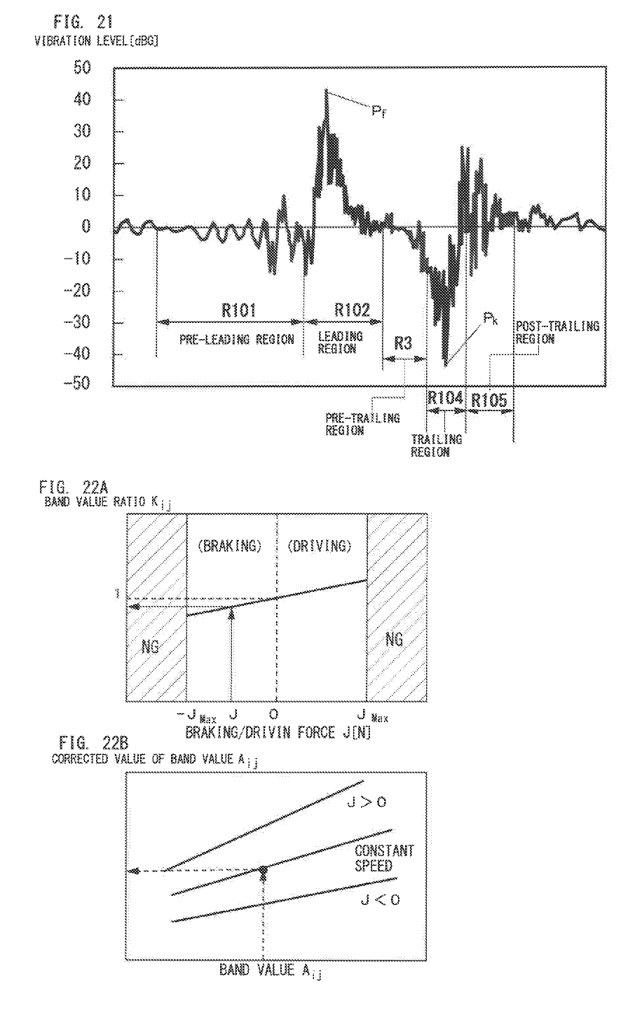

As illustrated in FIG. 20, the acceleration sensor 111 is disposed at the center of an inner liner portion 102 of a tire 101 in a tire width direction such that the detection direction thereof is a tire circumferential direction. As a result of this, the acceleration sensor 111 detects an acceleration rate in the tire circumferential direction input applied from a road surface to a tread 103. Hereinafter, a position of the acceleration sensor 111 (strictly, a position on the surface of the tread 103 disposed on the outside of the acceleration sensor 111 in the radial direction) will be referred to as a measurement point.

Output of the acceleration sensor 11 is transmitted to, for example, the vibration waveform detection means 114 by a transmitter 111F.

The braking/driving force estimating means 112 estimates a braking/driving force J applied to the tire. Specifically, a driving force applied to the tire is estimated from an accelerator opening and a gear position, and a braking force is estimated from a brake pedal pressing force or a brake oil pressure. J>0 corresponds to a driving force and J<0 corresponds to a braking force.

To be noted, the braking/driving force J applied to the tire may be estimated from either or both of information of a vehicle body acceleration rate and road surface slope information, or the braking/driving force J applied to the tire may be estimated from any or a plurality of pieces of information of vehicle body speed, wheel speed, and road surface slope information.

The braking/driving force determination means 113 determines, from the estimated braking/driving force J, whether or not the state of the tire 101 is a state in which determination of the road surface state can be performed. Specifically, in the case where the magnitude |J| of the estimated braking/driving force J exceeds a threshold value J_{Max}, it is determined that determination of the road surface state from the detected vibration waveform is difficult, and determination of the road surface state is stopped by transmitting a stopping instruction signal for stopping detection of the vibration waveform to the vibration waveform detection means 114.

In contrast, in the case where the magnitude |J| of the estimated braking/driving force J does not exceed the threshold value J_{Max} (−J_{Max}≤J≤J_{Max}), data of the braking/driving force J is output to the band value correction means 117.

To be noted, it is preferable that J_{Max} is within a range of 0.2 G to 0.8 G. In this example, J_{Max} is 0.4 G.

The vibration waveform detection means 114 detects a time series waveform in which vibration in the tire circumferential direction input to the tire 101 during travel, which is an output of the acceleration sensor 111, is arranged in time series. As illustrated in FIG. 21, a peak (positive peak) P_{f} appearing first in the time series waveform of vibration is a peak generated when a measurement point collides with a road surface, and the position of this peak P_{f} is a leading point P_{f}. A peak (negative peak) Pₖ appearing next is a peak generated when the measurement point is separated from the road surface, and the position of this peak Pₖ is a trailing point.

The region signal extraction means 115 divides the time series waveform detected by the vibration waveform detection means 114 into a pre-leading region R101 before the peak P_{f} on the leading side, a leading region R102 in which the peak P_{f} on the leading side is formed, a pre-trailing region R103 which is a region between the peak P_{f} on the leading side and the peak Pₖ on the trailing side, a trailing region R104 in which the peak Pₖ on the trailing side is formed, and a post-trailing region R105 after the trailing region R104, and thus extracts a time series waveform of vibration in each of the regions R101 to R105.

To be noted, in the case where the stop instruction signal has been input from the braking/driving force determination means 113, the extraction operation of the time series waveform is stopped.

The band value calculation means 116 subjects the respective time series waveforms of the regions R101 to R105 to band-pass filters, and calculates hand values Aᵢⱼ, which are magnitudes of vibration components in predetermined frequency regions. To be noted, the affix i indicates the regions R101 to R105 of the time series waveform, and the affix j indicates an extracted frequency region.

For example, A₁₁ is a band value selected from a 2 kHz-8 kHz hand of the pre-leading region R101, A₂₃ is a band value selected from a 4 kHz-10 kHz band of the leading region R102, and A₅₂ is a band value selected from a 2 kHz-4 kHz band of the post-trailing region R105.

This band value Aᵢⱼ corresponds to a determination parameter of the present invention.

The band value correction means 117 corrects the hand value Aᵢⱼ calculated by the hand value calculation means 116 by using data of the braking/driving force J estimated by the braking/driving force determination means 113. Specifically, a graph illustrating a relationship between the braking/driving force J and a band value ratio Kᵢⱼ=aᵢⱼ(J)/aᵢⱼ(0) as illustrated in FIG. 22 is prepared, and a band value Aᵢⱼ(J) when the braking/driving force J is corrected. To be noted, aᵢⱼ(0) is a band value during constant-speed driving (J=0).

When a corrected band value is expressed as Aᵢⱼ(J), Aᵢⱼ(J)=Kᵢⱼ×Aᵢⱼ holds.

To be noted, not all the band values Aᵢⱼ is larger during acceleration (J>0) and smaller during deceleration (J<0) as illustrated in FIG. 22A. Therefore, as described above, a graph showing a relationship between the braking/driving force J and the band value ratio Kᵢⱼ needs to be prepared for each extraction region Ri and extraction frequency region jj.

To be noted, the method for correcting the band values Aᵢⱼ is not limited to the method described above, and, as illustrated in FIG. 22B, a straight line or a curved line indicating a relationship between Aᵢⱼ and Aᵢⱼ(J) may be obtained in advance for each braking/driving force J, and Aᵢⱼ(J) on the straight line or curved line corresponding to a braking/driving force J with of Aᵢⱼ may be used as a corrected value.

The road surface state determination means 118 estimates the road surface state by using a function value fk obtained by using the band value Aᵢⱼ(J) corrected by the band value correction means 117 instead of Aᵢⱼ calculated by the band value calculation means 16 in a plurality of preset discriminant functions Fk(Aᵢⱼ).

In this example, as the discriminant functions Fk, a discriminant function F1=w₁₁·A₁₁+w₁₂·A₁₂−K1 for determining whether an interposed matter such as water or snow is present on the road surface, F2=w₂₁·A₂₁+w₂₂·A₅₁−K2 for determining whether or not the road surface is a snow-covered surface, and F3=w₃₁·A₅₂+w₃₂·A₃₁+w₃₃·A₄₁+w₃₄·A₅₃ for determining which of water and snow the interposed matter on the road surface is, that is, which of a deep WET road surface and a deep sherbet-like snow road the road surface is, which the present applicant has proposed in Japanese Patent Application No. 2010-115730 (Patent Literature 1), are used, and whether or not the road surface is a “snow road” and which of a “snow-covered road” and a “shallow sherbet-like snow road” the “snow road” is are determined.

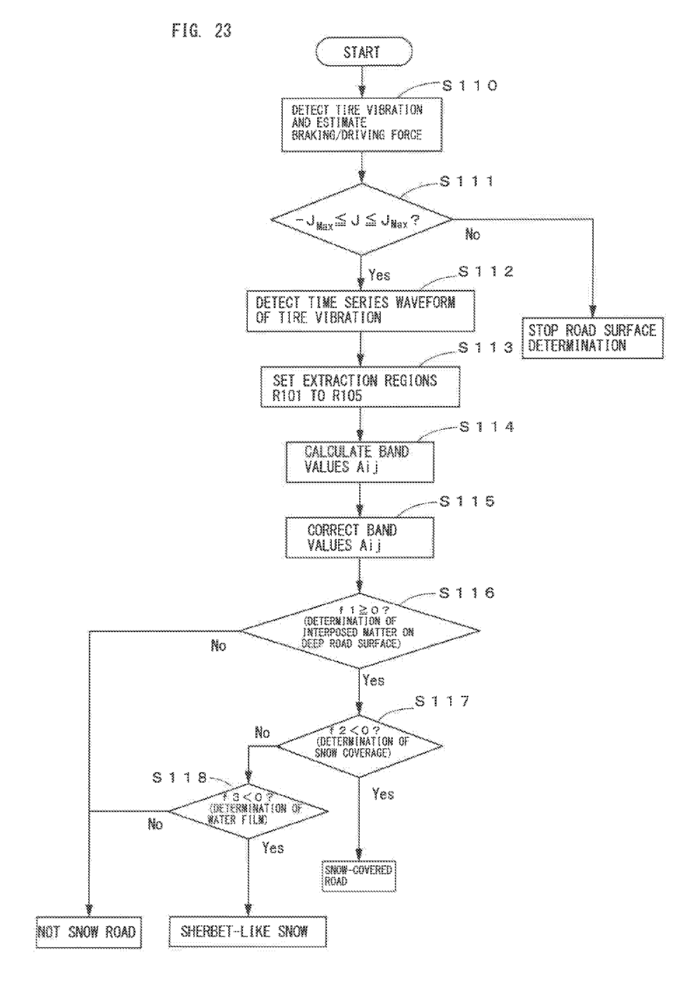

Next, a road surface state determination method according to Embodiment 4 will be described with reference to a flowchart of FIG. 23.

First, vibration in the tire circumferential direction of the tire 101 during travel is detected by the acceleration sensor 111, and the braking/driving force J applied to the tire 101 is estimated by the braking/driving force estimating means 112 (step S110).

Next, whether or not the magnitude |J| of the estimated braking/driving force J is equal to or smaller than the threshold value J_{Max} (−J_{Max}≤J≤J_{Max}) is determined (step S111).

In the case where the magnitude |J| of the braking/driving force J is equal to or smaller than the threshold value J_{Max}, the process proceeds to step S112, a time series waveform in which the vibration in the tire circumferential direction, which is the output of the acceleration sensor 111, is arranged in time series is detected, then the time series waveform that is data of tire vibration is subjected to window multiplication by a preset time window, and thus a time series waveform of tire vibration for each time window is extracted (step S113).

In contrast, in the case where the estimated braking/driving force J is J<−J_{Max} or J>J_{Max}, the extraction of time series waveform of tire vibration is stopped.

In this example, J_{Max} is 0.4 G and J is 0.1 G.

Next, the detected time series waveform is divided into the pre-leading region R101, the leading region R102, the pre-trailing region R103, the trailing region R104, and the post-trailing region R105 (step S113), and then the band values Aᵢⱼ are calculated from time series waveforms of vibration in the respective regions R101 to R105 (step S114).

The band values Aᵢⱼ are band values whose extraction region of time series waveform is Ri and whose frequency region is [fⱼₐ, f_{jb}]. For example, A₂₃ is a band value of the leading region R2 in a frequency region [4 kHz, 10 kHz].

In the present invention, the calculated band values Aᵢⱼ are corrected by using data of the braking/driving force J (step S115). To be noted, the correction is performed on each band value Aᵢⱼ.

Next, whether or not there is an interposed matter such as water or snow on the road surface is determined (step S116).

Specifically, a discriminant function F1=w₁₁·A₁₁+w₁₂·A₁₂−K1 is set by experimentally obtaining a relationship between a band value A₁₁ and a band value A₁₂ in various road surface states in advance, and a function value f1 is obtained by using, as a band value A₁₁ and a band value A₁₂ in this discriminant function F1, a band value A₁₁(J) and a band value A₁₂(J) that have been respectively corrected by using the braking/driving force J

In the case where the function value f1 satisfies f1≥0, it is determined that an interposed matter such as water or snow is present on the road surface, therefore the process proceeds to step S117, and whether or not the interposed matter on the road surface is soft fresh snow that has piled up is determined. In contrast, in the case where f1<0 holds, it is determined that the road surface is “not a snow road”.

In step S117, whether or not it is a snow-covered road on which fresh snow has piled up is determined.

Specifically, a discriminant function F2=w₂₁·A₂₁+w₂₂·A₅₁−K2 is set by experimentally obtaining a relationship between a band value A₂₁ and a band value A₅₁ in various road surface states in advance, and a function value f2 is obtained by using, as a band value A₂₁ and a band value A₅₁ in this discriminant function F2, a band value A₂₁(J) and a band value A₅₁(J) that have been respectively corrected by using the braking/driving force J. In the case where f2<0 holds, it is determined that the road surface is a snow-covered road.

In contrast, in the case where the function value f2 satisfies f2≥0, the process proceeds to step S118, and which of water and snow the interposed matter on the road surface is, that is, which of a deep WET road surface and a deep sherbet-like snow road the road surface is is determined.

That is, in step S118, a discriminant function F3=w₃₁·A₅₂+w₃₂·A₃₁+w₃₃·A₄₁+w₃₄·A₅₃ is set for band values A₅₂, A₅₃₁, A₄₁, and A₅₃ in various road surface states, and a function value f3 is obtained by using, as band values A₅₂, A₃₁, A₄₁, and A₅₃ in this discriminant function F3, band values A₅₂(J), A₃₁(J), A₄₁(J), and A₅₃(J) that have been respectively corrected by using the braking/driving force J. In the case where f3≥0 holds, determination is made as a deep WET road (not a snow road), and in the case where f3<0 holds, the road surface is determined as a sherbet-like snow road.

As described above, in Embodiment 4, the vibration in the tire circumferential direction of the tire 1 during travel is detected by the acceleration sensor 111, the braking/driving force J applied to the tire 1 is estimated by the braking/driving force estimating means 112, and in the case where the magnitude |J| of the estimated braking/driving force J is equal to or smaller than the threshold value J_{Max} (−J_{Max}≤J≤J_{Max}), the band values Aᵢⱼ obtained from the time series waveform of the vibration in the tire circumferential direction serving as determination parameters are corrected by using the braking/driving force J, and the road surface state is determined by using the corrected band values Aᵢⱼ(J). Therefore, the determination accuracy of the road surface state can be improved.

In addition, since the determination of the road surface state is stopped in the case where the braking/driving force J is J<−J_{Max} or J>J_{Ma}, erroneous determination of the road surface state can be prevented.

To be noted, although the braking/driving force J is used as the external information input to the tire in Embodiment 4, a lateral force applied to the tire or both of the braking/driving force J and the lateral force may be used as the external information. Alternatively, a resultant force of the braking/driving force J and the lateral force may be used as the external information.

In addition, although the band values Aᵢⱼ, which are magnitudes of vibration components of predetermined frequency regions calculated from time series waveforms of the pre-leading region R101, the leading region R102, the pre-trailing region R103, the trailing region R104, and the post-trailing region R105 extracted from a time series waveform, are used as a determination parameter corrected by using the external information in Embodiment 4 described above, a function value fk of a discriminant function Fk, which is a calculated value calculated from vibration levels of a plurality of specific frequency bands, may be used as the determination parameter corrected by using the external information. Alternatively, wₖᵢ (weight level), which is a coefficient of the discriminant function Fk, or a constant Kₖ may be used as the determination parameter corrected by using the external information.

The case where the function value fk of the discriminant function Fk is used as the determination parameter corrected by using the external information input to the tire corresponds to a first determination step of determining a road surface state by using a determination parameter and external information of the present invention.

In addition, a range of a specific frequency band may be used as the determination parameter.

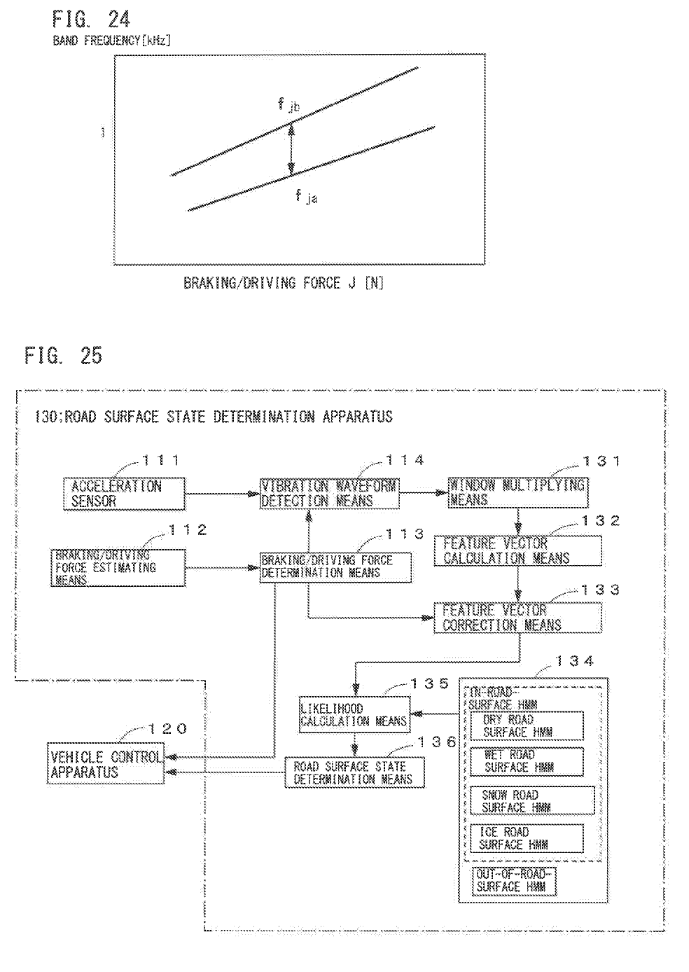

For example, as illustrated in FIG. 24, an upper limit frequency fⱼₐ and a lower limit frequency f_{jb} of a specific frequency region, or a region width (f_{jb}−fⱼₐ) of the specific frequency region changes in accordance with the braking/driving force J. Therefore, by changing these values in accordance with the braking/driving force J, the determination accuracy of the road surface state can be improved.

In addition, a time width of a window by which the vibration waveform is to be multiplied may be used as the determination parameter. That is, the position of the peak P_{f} on the leading side and the position of the peak Pₖ on the trailing side of the vibration waveform or also an interval position between the peak P_{f} on the leading side and the peak Pₖ on the trailing side change in accordance with the braking/driving force J. Therefore, by changing the time width of a window to be multiplied by a vibration waveform, which is a region width of the extraction regions (pre-leading region R101, leading region R102, pre-trailing region R103, trailing region R104, and post-trailing region R105) of the vibration waveform, in accordance with the braking/driving force J, the determination accuracy of the road surface state can be further improved.

In addition, by simultaneously correcting and changing a plurality of determination parameters, the determination accuracy of the road surface state can be further improved.

### Embodiment 5

FIG. 25 is a function block diagram of a road surface state determination apparatus 130 according to Embodiment 5. In this figure, 111 represents an acceleration sensor serving as a vibration detection means, 112 represents a braking/driving force estimating means, 113 represents a braking/driving force determination means, 114 represents a vibration waveform detection means, 131 represents a window multiplying means, 132 represents a feature vector calculation means, 133 represents a feature vector correction means, 134 represents a storage means, 135 represents a likelihood calculation means, and 136 represents a road surface state determination means.

To be noted, each means from the acceleration sensor 111 to the vibration waveform detection means 114 denoted by the same reference signs as in Embodiment 4 is the same as in Embodiment 4.

The acceleration sensor 111 detects the vibration in the tire circumferential direction of the tire 101 during travel, and the braking/driving force estimating means 112 estimates the braking/driving force J applied to the tire 101.

The braking/driving force determination means 113 determines whether the estimated braking/driving force J is within a preset determinable inner pressure range [−J_{Max}, J_{Max}], and the vibration waveform detection means 114 detects a time series waveform in which vibration in the tire circumferential direction is arranged as illustrated in FIG. 21.

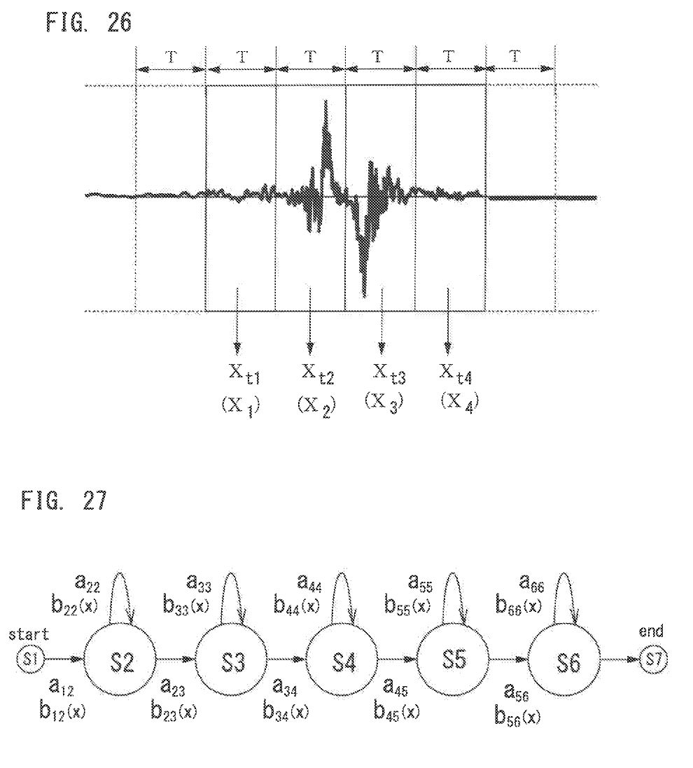

The window multiplying means 131 subjects the time series waveform of the vibration in the tire circumferential direction to window multiplication with a preset time width (time window width), and thus extracts a time series waveform of tire vibration for each time window as illustrated in FIG. 26.

The feature vector calculation means 132 calculates a feature vector Xₜ for each time series waveform extracted for each time window. In this example, as the feature vector Xₜ, vibration levels (power values of a filtered wave) xₖₜ of specific frequency bands extracted obtained by filtering each time series waveform of tire vibration by using k band pass filters BP(k) of frequency regions of fₖₐ to f_{kb}. The number of dimensions of a feature vector X is k, and, in this example, since the specific frequency bands are set to six bands of 0 to 0.5 kHz, 0.5 to 1 kHz, 1 to 2 kHz, 2 to 3 kHz, 3 to 4 kHz, and 4 to 5 kHz, k is 6.

Since the feature vector Xₜ is obtained for each time window, when the total number of time windows is N, the number of feature vectors Xₜ is also N.

The feature vector correction means 133 corrects, by using the data of the braking/driving force J applied to the tire transmitted from the braking/driving force determination means 113, N×k power values xₖₜ (hereinafter referred to as power values xₖₜ) calculated by the feature vector calculation means 132. The method of correction is similar to that of Embodiment 4. That is, a graph indicating a power value ratio a relationship with Kₖ=xₖₜ(J)/xₖₜ(0) is prepared, power values xₖₜ of the case where the braking/driving force is J are corrected, and corrected feature vectors Xₜ(J) are obtained.

When components of the corrected feature vectors Xₜ(J) are xₖₜ(J), xₖₜ(J)=Kₖ×xₖₜ holds.

The storage means 134 stores a plurality of hidden Markov models (hereinafter referred to as road surface HMMs) constituted for respective road surface states. A road surface HMM is composed of an in-road-surface HMM (road) and an out-of-road-surface HMM (silent). The in-road-surface HMM (road) is constituted by a vibration waveform appearing in a road surface region in the time series waveform of tire vibration, and the out-of-road-surface HMM (silent) is constituted by a waveform in a region without information.

The road surface HMM has seven states S₁ to S₇ corresponding to the time series waveform of tire vibration as illustrated in FIG. 27, and the states S₁ to S₇ are each constituted by two kinds of parameters of emission probabilities bᵢⱼ(X) of the feature vector Xₜ and transition probabilities aᵢⱼ(X) between states (i, j=1 to 7).

In this example, learning of dividing the tire vibration into five states in five states of S₂ to S₆ excluding the start state S₁ and the end state S₇ of each road surface HMM is performed to obtain the emission probabilities bᵢⱼ(X) and the transition states aᵢⱼ(X) between states of the feature vector X of each road surface HMM.

An emission probability bᵢⱼ(X) represents the probability of the feature vector X being output when the state transitions from a state Sᵢ to a state Sⱼ. The emission probability bᵢⱼ(X) is assumed to have a mixed normal distribution.

A transition probability aᵢⱼ(X) represents the probability of the state transitioning from the state Sᵢ to the state Sⱼ.

To be noted, in the case where the number of dimensions of the feature vector X is k, the emission probability bᵢⱼ is set for each of k components xₖ of the feature vector X.

In this example, data of time series waveform obtained in advance by driving a vehicle including the tire 101 provided with the acceleration sensor 111 on respective road surfaces of DRY, WET, SNOW, and ICE is used as learning data, and thus five road surface HMMs composed of four in-road-surface HMMs (road) of a DRY road surface HMM, a WET road surface HMM, a SNOW road surface HMM, and an ICE road surface HMM and one out-of-road-surface HMM (silent) are constructed.

The in-road-surface HMM (road) and the out-of-road-surface HMM (silent) both are HMMs having the seven states of S₁ to S₇ including the start state S₁ and the end state S₇.

The learning of HMM is performed by a known method such as EM algorithm, Baum-Welch algorithm, and forward-backforward algorithm.

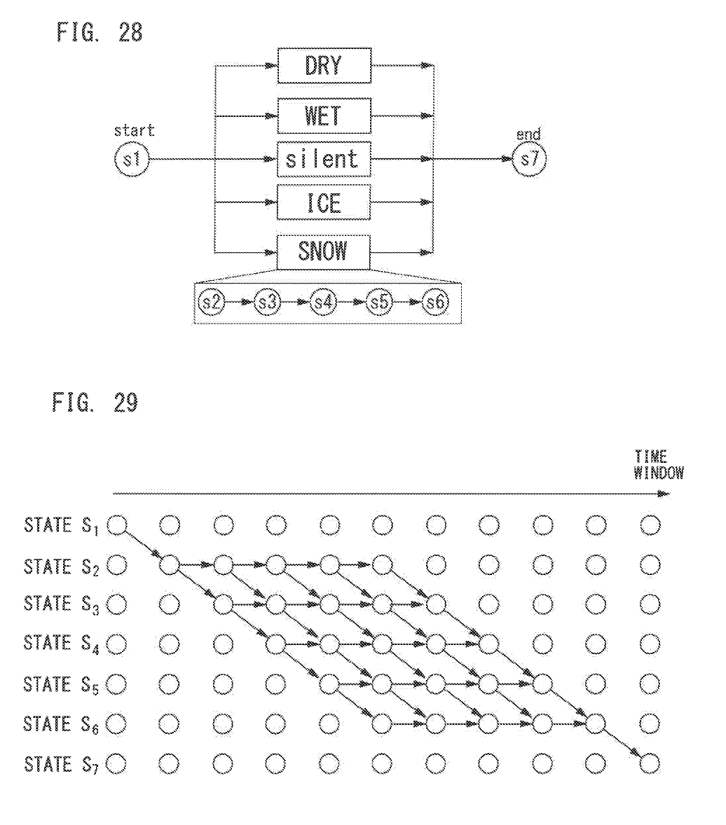

The likelihood calculation means 135 calculates likelihood of a feature vector Xₜ(J) corrected for each of a plurality of (four herein) road surface HMMs as illustrated in FIG. 28.

Regarding the likelihood, as the present applicants have proposed in Japanese Patent Application No. 2011-140943, first, an emission probability P(Xₜ(J)) is calculated for each time window by using the following formulae (1) and (2). To be noted, Xₜ represents a corrected feature vector Xₜ(J) hereinbelow.

$$\begin{matrix}[ Math . 5 ] & \\ P ( {X}_{t} ) = {\prod }_{s = 1}^{S} [ {\sum }_{m = 1}^{Ms} {c}_{jsm} N ( {X}_{st} \vert {μ}_{jsm} , {σ}_{jsm} ) ] & ( 1 ) \\ N ( X \vert μ , σ ) = \frac{1}{\sqrt{{( 2 π )}^{n} \vert σ \vert}} exp \{ - \frac{1}{2} ( x - μ ) {{σ}^{- 1} ( x - μ )}^{T} \} & ( 2 )\end{matrix}$$

X; data series
t; time
S; number of states
Mₛ; number of components in mixed Gauss distribution
cⱼₛₘ; mixture ratio of m-th mixture component
μ; average vector of Gauss distribution
σ; variance-covariance matrix of Gauss distribution

Since the road surface HMM has 7 states, a transition probability π(Xₜ) can be represented by a 7×7 matrix. As this transition probability π(Xₜ), the transition probability aᵢⱼ(Xₜ) between states of the feature vector Xₜ obtained by learning of the road surface HMM described above can be used.

Then, an appearance probability K(Xₜ) for each time window, which is a product of the calculated emission probability P(Xₜ) and the transition probability π(Xₜ) is obtained, and a likelihood Z is obtained by multiplying the appearance probability K(Xₜ) for each time window for all time windows. That is, the likelihood Z is obtained by Z=ΠP(Xₜ)·transition probability π(Xₜ). Alternatively, the likelihood Z may be obtained by calculating a log of the appearance probability K(Xₜ) calculated for each time window and adding the log for all time windows.

Incidentally, there are a plurality of paths (state transition series) through which the state of the road surface HMM transitions from the state S₁ to the state S₇ as illustrated in FIG. 29. That is, the likelihood Z is different between state transition series for each road surface HMM.

In this example, a state transition series Z_{M} with the highest likelihood Z is obtained by applying a known Viterbi algorithm, this state transition series is set as a state transition series corresponding to the detected time series waveform of tire vibration, and the likelihood Z_{M} is set as Z of the road surface HMM.

The likelihood Z_{M} is obtained for each road surface HMM.

The road surface state determination means 136 compares respective likelihoods of a plurality of hidden Markov models calculated by the likelihood calculation means 135, and determines a road surface state corresponding to a hidden Markov model with the highest likelihood as the road surface state of a road surface on which the tire is traveling.

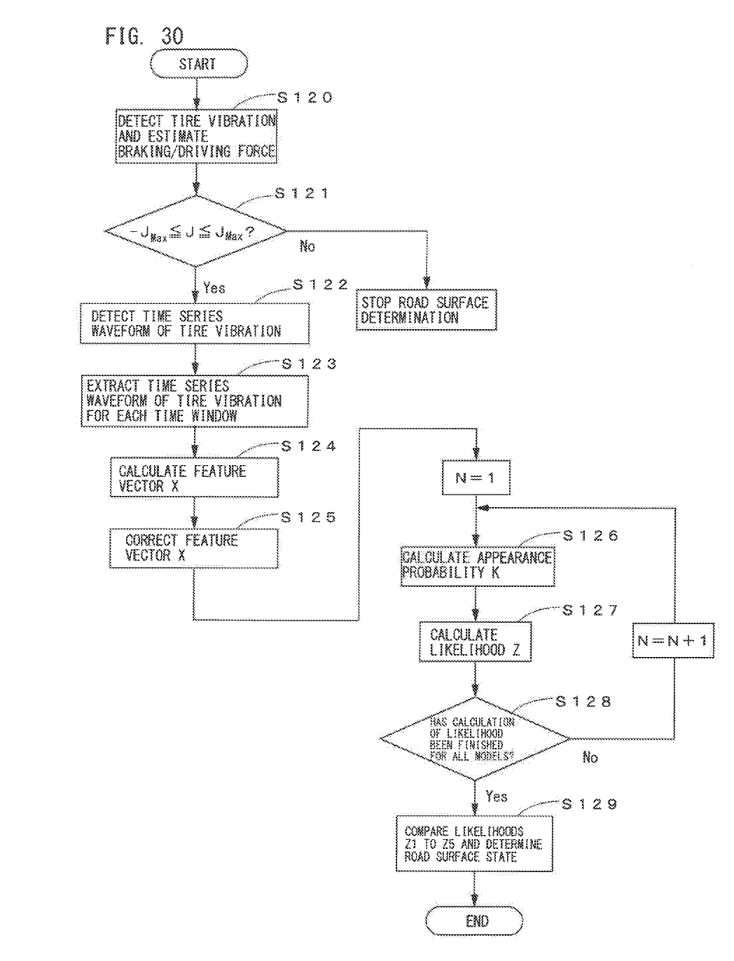

Next, a determination method of road surface state according to Embodiment 5 will be described with reference to a flowchart of FIG. 30.

First, the acceleration sensor 111 detects the vibration of the tire 101 in the tire circumferential direction during travel, and the braking/driving force estimating means 112 estimates the braking/driving force J applied to the tire 101 (step S120).

Next, whether or not the magnitude |J| of the estimated braking/driving force J is equal to or smaller than the threshold value J_{Max} (−J_{Max}≤J≤J_{Max}) is determined (step S121).

In the case where the magnitude |J| of the braking/driving force J is equal to or smaller than the threshold value J_{Max}, the process proceeds to step S122, a time series waveform in which the vibration in the tire circumferential direction, which is the output of the acceleration sensor 111, is arranged in time series is detected, then the time series waveform that is data of tire vibration is subjected to window multiplication by a preset time window, and thus a time series waveform of tire vibration for each time window is extracted (step S123).

In contrast, in the case where the estimated braking/driving force J is J<−J_{Max} or J>J_{Max}, the extraction of time series waveform of tire vibration is stopped.

In this example, J_{Max} is 0.4 G and J is 0.1 G.

In step S124, the feature vector Xₜ=(x₁ₜ, x₂ₜ, x₃ₜ, x₄ₜ, x₅ₜ, x₆ₜ) is calculated for each time series waveform extracted for each time window.

In the present invention, the power values x₁ₜ to x₆ₜ of filtered waves of the time series waveform of tire vibration, which are components of the calculated feature vector X, are corrected by using the data of the estimated braking/driving force J (step S125). To be noted, this correction is performed for each power value xₖₜ (k=1 to 6).

After correcting the power values xₖₜ, first, the appearance probability K(Xₜ)=emission probability P(Xₜ)×transition probability π(Xₜ) is obtained for each time window for the DRY road surface HMM serving as the first road surface HMM (step S26), and a likelihood Z1 of the DRY road surface HMM is calculated by multiplying the appearance probability K(Xₜ) for all time windows (step S127).

Next, whether or not the calculation of the likelihood Z has been finished for all the models is determined (step S128), and in the case where the calculation is not finished, the process returns to step S126, and a likelihood Z2 of the WET road surface HMM, which is the next model, is calculated.

In the case where the calculation of the likelihood Z for all the five models has been finished, the process proceeds to step S129, and the road surface state is determined. Specifically, likelihoods Z1 to Z5 calculated for respective road surface HMMs are compared, and a road surface state corresponding to a road surface HMM with the highest likelihood is determined as the road surface state of the road surface on which the tire is traveling.

As described above, in Embodiment 5, the vibration in the tire circumferential direction of the tire 101 during travel is detected by the acceleration sensor 111, the braking/driving force J applied to the tire 101 is estimated by the braking/driving force estimating means 112, and in the case where the estimated braking/driving force J is within the determinable inner pressure range [−J_{Max}, J_{Max}], the power values xₖₜ of filtered waves, which are components of the feature vector Xₜ calculated from the time series waveform of tire vibration extracted for each time window by window multiplication by the window multiplying means 131 are corrected by using the data of the braking/driving force J, and then the road surface state is determined by using the feature vector Xₜ(J) including the corrected power values xₖₜ(J) of filtered waves as components. Therefore, the determination accuracy of the road surface state can be improved.

In addition, since the determination of the road surface state is stopped in the case where the braking/driving force J is out of the determinable inner pressure range [−J_{Max}, J_{Max}], erroneous determination of the road surface state can be prevented.

To be noted, although the braking/driving force J is used as the external information input to the tire in Embodiment 5, a lateral force applied to the tire or both of the braking/driving force J and the lateral force may be used as the external information. Alternatively, a resultant force of the braking/driving force J and the lateral force may be used as the external information.

In addition, although the power values xₖₜ of filtered waves of time series waveforms of tire vibration, which are components of the feature vector Xₜ of the time series waveform extracted for each time window, is used as the determination parameter corrected by using the braking/driving force J serving as external information input to the tire in Embodiment 5 described above, the magnitude of the likelihood Z serving as a determination function may be used as the determination parameter. Alternatively, weight vectors of determination functions of the emission probability P(Xₜ) and the transition probability π(Xₜ) of the feature vector X of each road surface HMM, the number S of states, the number Mₛ of components in mixed Gauss distribution, the mixture ratio cⱼₛₘ of m-th mixture component, the average vector μ of Gauss distribution, variance-covariance matrix σ of Gauss distribution, and the like, or intermediate parameters of the weight vectors may be used as the determination parameter.

The case where the magnitude of the likelihood Z is used as the determination parameter corrected by using the tire state corresponds to a first determination step of determining a road surface state from the determination parameter and the external information of the present invention.

Parameters such as the emission probability P(Xₜ) and the transition probability π(Xₜ) corrected by using the braking/driving force J are obtained by learning of the road surface HMM.

In addition, appropriate values and time window width in the case where the frequency region of the band-pass filters BP(k) for obtaining the power values xₖₜ is fka−fkb may be used as the determination parameter.

In addition, by simultaneously correcting and changing a plurality of determination parameters, the determination accuracy of the road surface state can be further improved.

### Embodiment 6

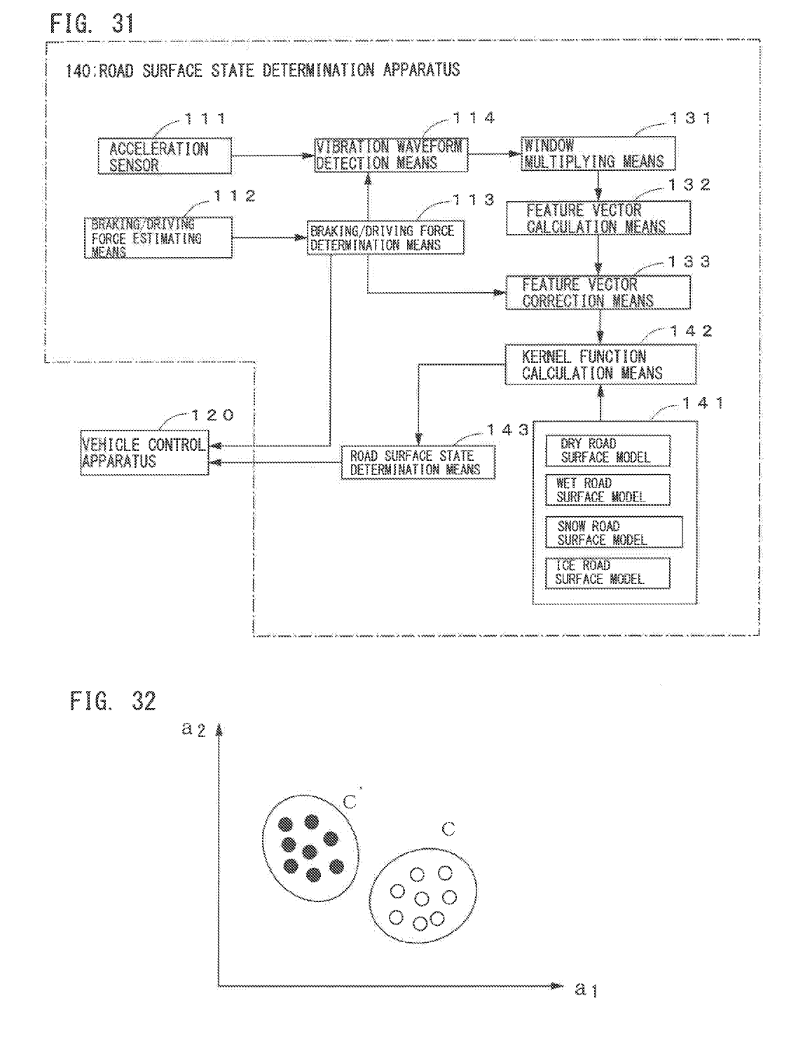

FIG. 31 is a function block diagram of a road surface state determination apparatus 140 according to Embodiment 6. In this figure, 111 represents an acceleration sensor, 112 represents a braking/driving force estimating means, 113 represents a braking/driving force determination means, 114 represents a vibration waveform detection means, 131 represents a window multiplying means, 132 represents a feature vector calculation means, 133 represents a feature vector correction means, 141 represents a storage means, 142 represents a kernel function calculation means, and 143 represents a road surface state determination means.

To be noted, each means from the acceleration sensor 11 to the vibration waveform detection means 114 denoted by the same reference signs as in Embodiment 4 and each means from the window multiplying means 131 to the feature vector correction means 133 denoted by the same reference signs as in Embodiment 5 are the same as in Embodiments 4 and 5.

The acceleration sensor 11 detects the vibration in the tire circumferential direction of the tire 101 during travel, and the braking/driving force estimating means 112 estimates the braking/driving force J applied to the tire 101.

The braking/driving force determination means 113 determines whether the estimated braking/driving force J is within a preset determinable inner pressure range [−J_{Max}, J_{Max}], and the vibration waveform detection means 114 detects a time series waveform in which vibration in the tire circumferential direction is arranged as illustrated in FIG. 21.

In addition, the window multiplying means 131 subjects the time series waveform of the vibration in the tire circumferential direction to window multiplication with a preset time width (time window width), and thus extracts a time series waveform of tire vibration for each time window as illustrated in FIG. 26.

The feature vector calculation means 132 calculates a feature vector X, for each time series waveform extracted for each time window.

In this example, as the feature vector Xₜ, vibration levels (power values of a filtered wave) xₖₜ (k=1 to 6) of specific frequency bands respectively obtained by filtering each time series waveform of tire vibration by using band pass filters of 0 to 1 kHz, 1 to 2 kHz, 2 to 3 kHz, 3 to 4 kHz, and 4 to 5 kHz are used.

Since the feature vector Xₜ is obtained for each time window, when the total number of time windows is N, the number of feature vectors Xₜ is also N. Hereinafter, a feature vector whose window number is i will be described as Xᵢ, and power values that are components of Xᵢ will be described as xₖᵢ.

The feature vector correction means 133 corrects, by using the braking/driving force J applied to the tire transmitted from the braking/driving force determination means 113, N×k power values xₖᵢ calculated by the feature vector calculation means 132. The method of correction is similar to that of Embodiment 1. That is, a graph indicating a relationship between a power value ratio and Kₖ=xₖₜ(J)/xₖₜ(0) is prepared, power values x, of the case where the braking/driving force is J are corrected, and corrected feature vectors Xₜ(J) are obtained.

When components of the corrected feature vectors Xₜ(J) are xₖₜ(J), xₖₜ(J)=Kₖ×xₖₜ holds.

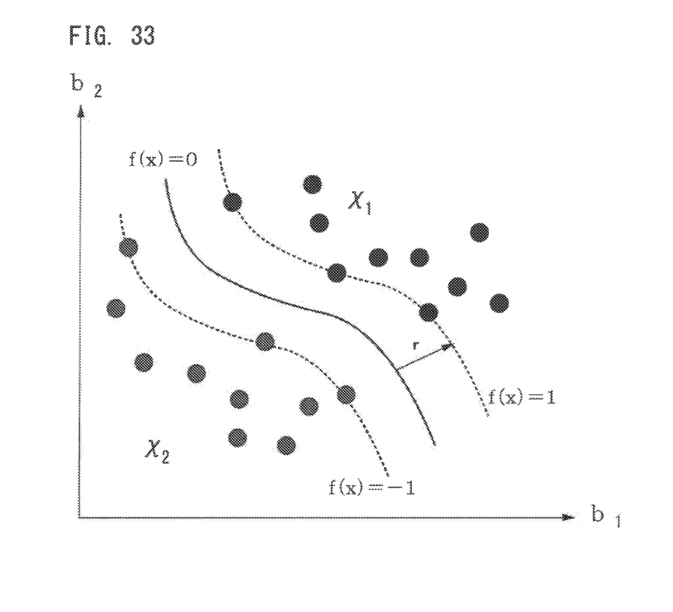

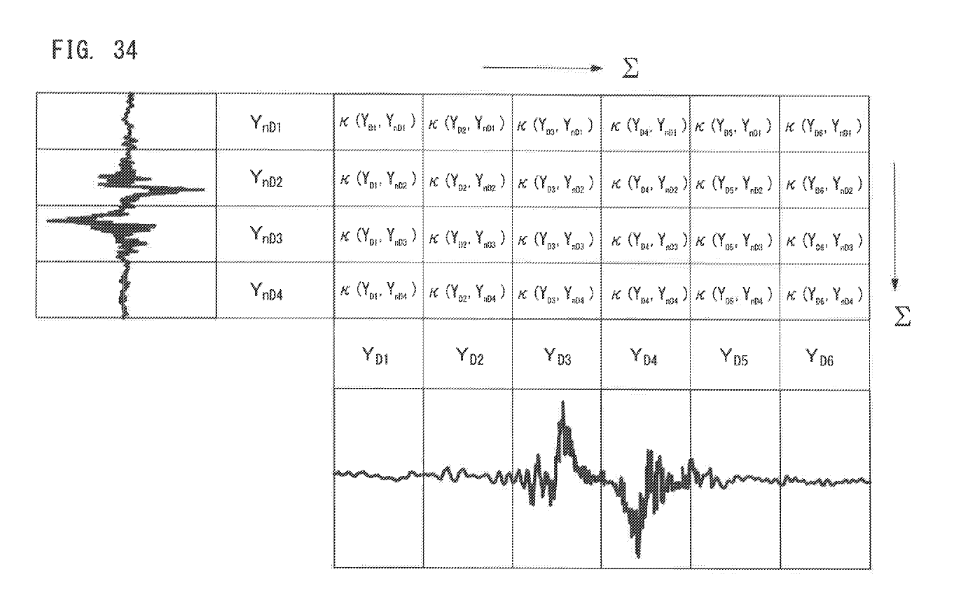

FIG. 32 is a schematic diagram illustrating an input space of the feature vector Xᵢ, in which each axis represents a vibration level aᵢₖ of a specific frequency band, which is a feature value, and each point represents a feature vector Xᵢ. Although the actual input space is a seven-dimensional space in total with the time axis because the number of specific frequency bands is 6, this figure is illustrated in two dimensions (the horizontal axis represents a₁ and the vertical axis represents a₂).

For example, assuming that the vehicle is driving on a DRY road surface, if points composing a group C can be distinguished from a group C′ composed of feature vectors X′ᵢ calculated when the vehicle is driving on a SNOW road surface, whether the vehicle is driving on a DRY road surface or on a SNOW road surface can be determined.

The storage means 141 stores four road surface models for separating a DRY road surface from the other road surfaces, a WET road surface from the other road surfaces, a SNOW road surface from the other road surfaces, and an ICE road surface from the other road surfaces by a discriminant function f(x) representing a separating hyperplane.

The road surface models are obtained by learning by using, as input data, a road surface feature vector Y_{ASV}(yⱼₖ), which is a feature vector for each time window calculated from a time series waveform of tire vibration obtained by driving a test car including a tire to which an acceleration sensor is attached on respective road surfaces of DRY, WET, SNOW, and ICE at various speeds.

To be noted, only one kind of tire size may be used for the learning, or a plurality of kinds of tire sizes may be used for the learning.

The suffix A of the road surface feature vector Y_{ASV}(yⱼₖ) represents DRY, WET, SNOW, and ICE. The suffix j (j=1 to M) represents the number of time series waveforms (window number) extracted by time windows, and the suffix k indicates a component of a vector. That is, yⱼₖ=(aⱼ₁, aⱼ₂, aⱼ₃, aⱼ₄, aⱼ₅, aⱼ₆) holds. In addition, SV is an abbreviation of support vector, and represents data in the vicinity of a decision boundary selected by the learning.

Hereinafter, the road surface feature vector Y_{ASV}(yⱼₖ) will be simply described as Y_{ASV}.

The calculation method for each road surface feature vector Y_{ASV} is similar to that of the feature vector Xⱼ described above. For example, in the case of a DRY road surface feature vector Y_{DSV}, a time series waveform of tire vibration when driving on a DRY road surface is subjected to window multiplication with a time width T, a time series waveform of tire vibration is extracted for each time window, and a DRY road surface feature vector Y_{D} is calculated for each time series waveform extracted for each time window. To be noted, the number of dimensions of a vector yᵢ of the DRY road surface feature vector Y_{D} is 6 similarly to the feature vector Xᵢ. Then, by performing learning by a support vector machine (SVM) by using Y_{D} as learning data, a support vector Y_{DSV} is selected. To be noted, the storage means 141 does not have to store all Y_{D}, and only the selected Y_{DSV} described above may be stored.

A WET road surface feature vector Y_{WSV}, a SNOW road surface feature vector Y_{SSV}, and an ICE road surface feature vector Y_{ISV} can be obtained in a similar manner to the DRY road surface feature vector Y_{DSV}.

Here, it is important that the time width T is the same value as the time width T of the case of obtaining the feature vector Xⱼ. In the case where the time width T is constant, the number M of time series waveforms of time windows varies depending on the kind of tire and the vehicle speed. That is, the number M of time series waveforms of time windows of the road surface feature vector Y_{ASV} does not necessarily coincide with the number N of time series waveforms of time windows of the feature vector Xⱼ. For example, even in the case where the kind of tire is the same, M>N holds when the vehicle speed at the time of obtaining the feature vector Xⱼ is lower than the vehicle speed at the time of obtaining the DRY mad surface feature vector Y_{DSV}, and M<N holds when the former is higher than the latter.

The road surface model can be constructed by SVM by using respective road surface feature vectors Y_{A} as learning data as proposed by the present applicants in Japanese Patent Application No. 2012-176779.

FIG. 33 is a conceptual diagram illustrating a DRY road surface feature vector Y_{DSV} and a road surface feature vector Y_{nDSV} not of a DRY road surface in an input space, and in this figure, black dots represent road surface feature vectors of DRY road surfaces, and dots of a lighter color represent road surface feature vectors not of a DRY surface.

To be noted, although both the DRY road surface feature vector and the road surface feature vector not of a DRY road surface are matrices, the DRY road surface feature vector and the road surface feature vector not of a DRY road surface are each represented as a two-dimensional vector in FIG. 32 for explaining how a group decision boundary is obtained.

Generally, linear separation cannot be performed at a group decision boundary. Therefore, nonlinear classification is performed on road surface feature vectors Y_{DSV} and Y_{nDSV} in the original input space by mapping the road surface feature vectors Y_{DSV} and Y_{nDSV} in a feature space of a higher dimension by nonlinear mapping φ by using a kernel method.

Specifically, a discriminant function f(x)=w^{T} φ(x)−b most suitable for identifying data is obtained by using a data set X=(x₁, x₂, . . . xₙ) and a belonging class z=(1, −1). Here, the data is the road surface feature vectors Y_{Dj} and Y_{nDj}, a belonging class z=1 indicates data of a DRY road surface indicated by χ₁ in the figure, and z=−1 indicates data of a road surface different from a DRY road surface indicated by χ₂. In addition, w is a weight coefficient, b is a constant, and f(x)=0 corresponds to the decision boundary.

The discriminant function f(x)=w^{T} φ(x)−b is optimized by using, for example, a method of Lagrange multiplier. The optimization problem can be replaced by the following formulae (3) and (4).

$$\begin{matrix}[ Math . 6 ] & \\ \begin{matrix}maximize & {\sum }_{α}^{ } {λ}_{α} - \frac{1}{2} {\sum }_{α : β}^{ } {λ}_{α} {λ}_{β} {z}_{α} {z}_{β} φ ( {x}_{α} ) φ ( {x}_{β} )\end{matrix} & ( 3 ) \\ \begin{matrix}subject to & {\sum }_{α}^{ } {λ}_{α} {z}_{α} = 0 , {λ}_{α} > 0\end{matrix} & ( 4 )\end{matrix}$$

Here, α and β are indices of a plurality of pieces of learning data. In addition, λ is a Lagrange multiplier which satisfies λ>0.

In this case, the discriminant function f(x)=w^{T}φ(x)−b can be non-linearized by replacing an inner product φ(x_{α})φ(x_{β}) by a kernel function K(x_{α}, x_{β}). To be noted, φ(x_{α})φ(x_{β}) is an inner product after mapping x_{α} and x_{β} in a high-dimension space by mapping φ.

The Lagrange multiplier λ can be obtained by using an optimization algorithm such as a gradient descent method or sequential minimal optimization (SMO) on the formula (2) described above. In this case, since a kernel function is used, the high-dimension inner product does not have to be directly obtained. Therefore, the calculation time can be greatly reduced.

In this example, a global alignment kernel function (GA kernel) is used as the kernel function K(x_{α}, x_{β}). The GA kernel K(x_{α}, x_{β}) is a function constituted by the sum or the product of all local kernels κᵢⱼ(xᵢ, xⱼ) representing a degree of similarity between the DRY road surface feature vector xᵢ=Y_{Di} and the road surface feature vector xⱼ=Y_{nDj} not of a DRY road surface as shown in FIG. 16 and the following formulae (5) and (6), and can directly compare time series waveforms of different time lengths.

The local kernel κᵢⱼ(xᵢ, xⱼ) is obtained for each window at a time interval T.

To distinguish the DRY road surface and the road surface different from the DRY road surface, the DRY road surface and the road surface different from the DRY road surface can be distinguished from each other with a high accuracy by providing a margin to the discriminant function f(x), which is a separating hyperplane that separates the DRY road surface feature vector Y_{Dj} and the road surface feature vector Y_{nDj} not of the DRY road surface.

The margin refers to a distance from the separating hyperplane to the closest sample (support vector), the separating hyperplane, which is the decision boundary, is f(x)=0. All the DRY road surface feature vectors Y_{Dj} are in a region of f(x)≥+1, and the road surface feature vectors Y_{nDj} not of the DRY road surface are in a region of f(x)≤−1.

The DRY road surface model that distinguishes the DRY road surface from the other road surfaces is an input space including a support vector Y_{DSV} in a distance of f(x)=+1 and a support vector Y_{nDSV} in a distance of f(x)=−1. Generally, Y_{DSV} and Y_{nDSV} described above are present in plural numbers.

The same applies to a WET model that distinguishes the WET road surface from the other road surfaces, a SNOW model that distinguishes the SNOW road surface from the other road surfaces, and an ICE model that distinguishes the ICE road surface from the other road surfaces.

In this example, a global alignment kernel function (GA kernel) is used as the kernel function K(x_{α}, x_{β}). The GA kernel K(x_{α}, x_{β}) is a function constituted by the sum or the product of all local kernels κᵢⱼ(xᵢ, xⱼ) representing a degree of similarity between the DRY road surface feature vector xᵢ=Y_{Di} and the road surface feature vector xⱼ=Y_{nDj} not of a DRY road surface as shown in FIG. 7 and the following formulae (5) and (6), and can directly compare time series waveforms of different time lengths.

$$\begin{matrix}[ Math . 7 ] & \\ K ( {x}_{α} , {x}_{β} ) = {\sum }_{i = 1}^{m} {\sum }_{j = 1}^{n} {κ}_{ij} ( {x}_{α i} , {x}_{β j} ) & ( 5 ) \\ {κ}_{ij} ( {x}_{α i} , {x}_{β j} ) = exp ( - \frac{{‖ {x}_{α i} , {x}_{β j} ‖}^{2}}{{σ}^{2}} ) & ( 6 )\end{matrix}$$

wherein ∥x_{αi}−x_{βj}∥ is a distance (norm) between feature vectors, and σ is a constant.

The local kernel κᵢⱼ(xᵢ, xⱼ) is obtained for each window of a time interval T.

To be noted, FIG. 25 illustrates an example in which a GA kernel of the DRY road surface feature vector Y_{Dj} whose number of time windows is 6 and the road surface feature vector Y_{nDj} not of a DRY road surface whose number of time windows is 4 is obtained.

To distinguish the DRY road surface and the road surface different from the DRY road surface, the DRY road surface and the road surface different from the DRY road surface can be distinguished from each other with a high accuracy by providing a margin to the discriminant function f(x), which is a separating hyperplane that separates the DRY road surface feature vector Y_{Dj} and the road surface feature vector Y_{nDj} not of the DRY road surface.

The margin refers to a distance from the separating hyperplane to the closest sample (support vector), the separating hyperplane, which is the decision boundary, is f(x)=0. All the DRY road surface feature vectors Y_{Dj} are in a region of f(x)≥+1, and the road surface feature vectors Y_{nDj} not of the DRY road surface are in a region of f(x)≤−1.

The DRY road surface model that distinguishes the DRY road surface from the other road surfaces is an input space including a support vector Y_{DSV} in a distance of f(x)=+1 and a support vector Y_{nDSV} in a distance of f(x)=−1. Generally, Y_{DSV} and Y_{nDSV} described above are present in plural numbers.

The same applies to a WET model that distinguishes the WET road surface from the other road surfaces, a SNOW model that distinguishes the SNOW road surface from the other road surfaces, and an ICE model that distinguishes the ICE road surface from the other road surfaces.

The kernel function calculation means 142 respectively calculates GA kernels K_{D}(X, Y), K_{W}(X, Y), K_{S}(X, Y), and K_{I}(X, Y) from the feature vector Xᵢ(J) calculated by the feature vector calculation means 132 and corrected by the feature vector correction means 133, and from respective support vectors Y_{ASV} and Y_{nASV} (A=D, W, S, and I) of the DRY model, the WET model, the SNOW model, and the ICE model stored in the storage means 141.

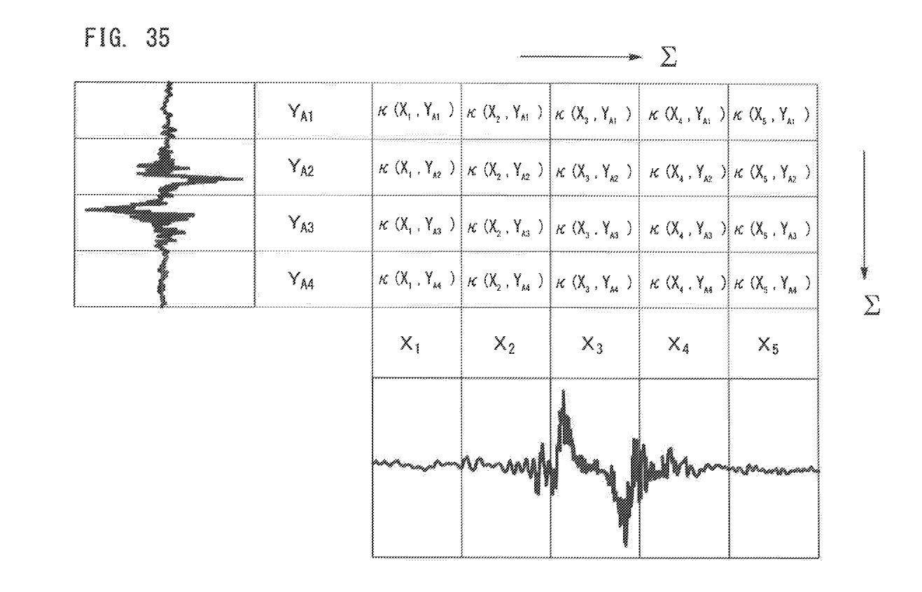

As illustrated in FIG. 35, the GA kernel K(X, Y) is a function constituted by the sum or the product of all local kernels κᵢⱼ(Xᵢ, Yⱼ) when xᵢ is the feature vector Xᵢ and xⱼ is the road surface vector Y_{Aj} or Y_{nAj} in [Math. 3] described above, and can directly compare time series waveforms of different time lengths. To be noted, this figure illustrates an example in which xⱼ is the road surface feature vector Y_{Aj}, the number of time windows of the feature vector Xᵢ is n=5, and the number of time windows of the road surface feature vector Y_{Aj} is m=4.

As in this example, the degree of similarity between feature vectors Xᵢ and Y_{Aj} (or between Xᵢ and Y_{nAj}) can be obtained even in the case where the number n of time series waveforms of time windows in the case of obtaining the feature vector Xᵢ and the number m of time series waveforms of time windows in the case of obtaining the road surface feature vector Y_{Aj} (or Y_{nAj}) are different.

The road surface state determination means 143 determines the road surface state on the basis of values of four discriminant functions f_{A}(x) (A=D, W, S, and I) using kernel functions K_{A}(X, Y) shown in the following formulae (7) to (10).

$$\begin{matrix}[ Math . 8 ] & \\ {f}_{D} = {\sum }_{α = 1}^{{N}_{DSV}} {λ}_{{D}_{α}} {z}_{{D}_{α}} {K}_{D} ( X , {Y}_{α} ) - {b}_{D} & ( 7 ) \\ {f}_{W} = {\sum }_{α = 1}^{{N}_{WSV}} {λ}_{{W}_{α}} {z}_{{W}_{α}} {K}_{W} ( X , {Y}_{α} ) - {b}_{W} & ( 8 ) \\ {f}_{S} = {\sum }_{α = 1}^{{N}_{SSV}} {λ}_{{S}_{α}} {z}_{{S}_{α}} {K}_{S} ( X , {Y}_{α} ) - {b}_{S} & ( 9 ) \\ {f}_{I} = {\sum }_{α = 1}^{{N}_{ISV}} {λ}_{{I}_{α}} {z}_{{I}_{α}} {K}_{I} ( X , {Y}_{α} ) - {b}_{I} & ( 10 )\end{matrix}$$

f_{D} is a discriminant function for distinguishing the DRY road surface from the other road surfaces, f_{W} is a discriminant function for distinguishing the WET road surface from the other road surfaces, f_{S} is a discriminant function for distinguishing the SNOW road surface from the other road surfaces, and f_{I} is a discriminant function for distinguishing the ICE road surface from the other road surfaces.

In addition, N_{DSV} is the number of support vectors of the DRY model, N_{WSV} is the number of support vectors of the WET model, N_{SSV} is the number of support vectors of the SNOW model, and N_{ISV} is the number of support vectors of the ICE model.

In this example, the discriminant functions f_{D}, f_{W}, f_{S}, and f_{I} are respectively calculated, and the road surface state is determined from the discriminant function indicating the largest value among the calculated discriminant functions f_{A}.

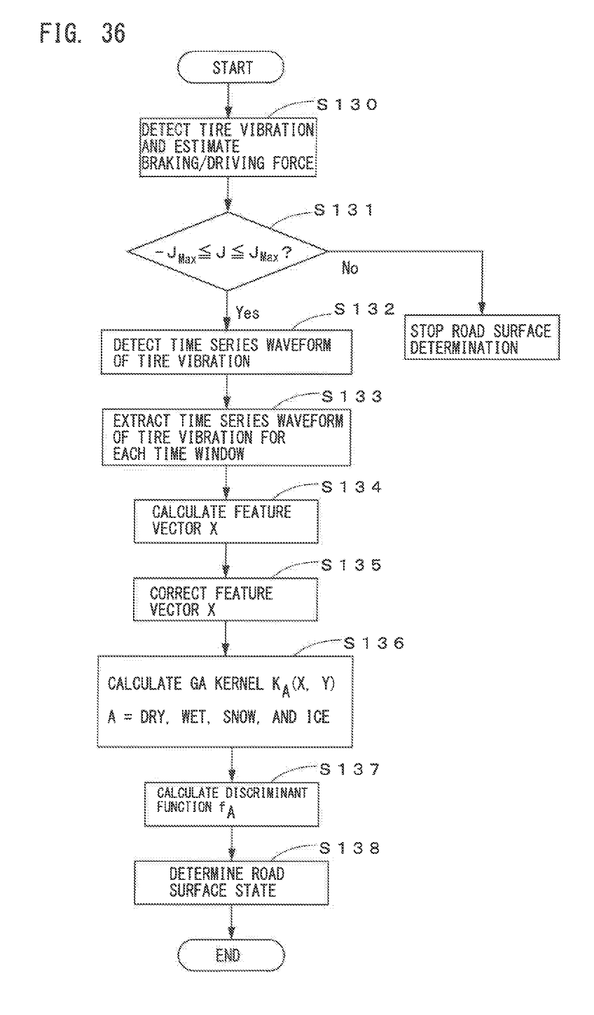

Next, a determination method of the road surface state according to Embodiment 6 will be described with reference to a flowchart of FIG. 36.

First, the acceleration sensor 111 detects the vibration of the tire 101 in the tire circumferential direction during travel, and the braking/driving force estimating means 112 measures the braking/driving force J applied to the tire 101 (step S130).

Next, whether or not the magnitude |J| of the estimated braking/driving force J is equal to or smaller than the threshold value J_{Max} (−J_{Max}≤J≤J_{Max}) is determined (step S131).

In the case where the magnitude |J| of the braking/driving force J is equal to or smaller than the threshold value J_{Max}, the process proceeds to step S132, a time series waveform in which the vibration in the tire circumferential direction, which is the output of the acceleration sensor 111, is arranged in time series is detected, then the time series waveform that is data of tire vibration is subjected to window multiplication by a preset time window, and thus a time series waveform of tire vibration for each time window is extracted (step S133).

In contrast, in the case where the estimated braking/driving force J is J<−J_{Max} or J>J_{Max}, the extraction of time series waveform of tire vibration is stopped.

In this example, J_{Max} is 0.4 G and J is 0.1 G.

In step S134, the feature vector Xₜ=(x₁ₜ, x₂ₜ, x₃ₜ, x₄ₜ, x₅ₜ, x₆ₜ) is calculated for each time series waveform extracted for each time window.

In the present invention, the power values x₁ₜ to x₆ₜ of filtered waves of the time series waveform of tire vibration, which are components of the calculated feature vector X, are corrected by using the data of the estimated braking/driving force J (step S135). To be noted, this correction is performed for each power value xₖₜ (k=1 to 6).

Next, the local kernels κᵢⱼ(Xᵢ, Yⱼ) are calculated from the corrected feature vector Xᵢ(J) and the support vector Y_{Ak} of the road surface model stored in the storage means 141, then the sum of all the local kernels κᵢⱼ(Xᵢ, Yⱼ) is obtained, and global alignment kernel functions K_{D}(X, Y), K_{W}(X, Y), K_{S}(X, Y), and K_{I}(X, Y) are respectively calculated (step S136).

Next, four discriminant functions f_{D}(X), f_{W}(x), f_{S}(x), and f_{I}(x) using the kernel functions K_{A}(X, Y) are respectively calculated (step S137), then the values of the calculated discriminant functions f_{A}(x) are compared, and the road surface state of the discriminant function indicating the largest value is determined as the road surface state of the road surface on which the tire 101 is traveling (step S138).

To be noted, although the braking/driving force J is used as the external information input to the tire in Embodiment 5, a lateral force applied to the tire or both of the braking/driving force J and the lateral force may be used as the external information. Alternatively, a resultant force of the braking/driving force J and the lateral force may be used as the external information.

To be noted, although the power values xₖₜ of filtered waves, which are components of the feature vector Xₜ of the time series waveform extracted for each time window, is used as the determination parameter corrected by using the tire state in Embodiment 6 described above, output values of the discriminant functions f_{D}, f_{W}, f_{S}, and f_{I} may be used as the determination parameter.

The case where an output value of the discriminant functions f_{D}, f_{W}, f_{S}, or f_{I} is used as the determination parameter corrected by using the braking/driving force J serving as external information input to the tire corresponds to a first determination step of determining a road surface state from the determination parameter and the state information of the present invention.

Alternatively, the belonging class z and the local kernels κᵢⱼ(Xᵢ, Yⱼ), which are parameters for obtaining the weight w of the discriminant function f(x), or the constant σ for calculating the local kernels κᵢⱼ(Xᵢ, Yⱼ) may be used as the determination parameter.

In addition, the kernel function to be used may be changed in accordance with the external information like, for example, changing the kernel function K to a dynamic time-warping kernel function (DTW kernel).

Alternatively, a parameter necessary for a learning process of a support vector machine may be used as the determination parameter.

In addition, similarly to Embodiment 2 described above, the determination accuracy of the road surface state can be also improved by using the appropriate values of frequency regions fka−fkb of the band pass filters BP(k) when obtaining the power values xₖₜ or the time width (time window width) for window multiplication of the time series waveform of the vibration in the tire circumferential direction as the determination parameter changed in accordance with the tire information.

In addition, by simultaneously correcting and changing the plurality of determination parameters, the determination accuracy of the road surface state can be further improved.

### REFERENCE SIGNS LIST

1: tire, 2: inner liner portion, 3: tread, 4: wheel rim, 5: tire air chamber, 10: road surface state determination apparatus, 11: acceleration sensor, 12: inner pressure sensor, 13: tire state determination means, 14: vibration waveform detection means, 15: region signal extraction means, 16: band value calculation means, 17: band value correction means, 18: road surface state determination means, 101: tire, 102: inner liner portion, 103: tread, 110: road surface state determination apparatus, 111: acceleration sensor, 112: braking/driving force estimating means, 113: braking/driving force determination means, 114: vibration waveform detection means, 115: region signal extraction means, 116: band value calculation means, 117: band value correction means, 118: road surface state determination means

1. A road surface state determination method for determining a state of a road surface from a time-varying waveform of vibration of a tire during travel detected by a vibration detection means, the road surface state determination method comprising:
a step of obtaining a vibration waveform of the tire;
a step of obtaining state information of the tire; and
either one determination step of a first determination step of determining a road surface state from a determination parameter that is obtained from the vibration waveform and is for determining the road surface state, and from the state information, and a second determination step of determining the road surface state, after correcting or changing the determination parameter by using the state information, from the corrected determination parameter.

2. The road surface state determination method according to claim 1, wherein the state information is either one or both of inner pressure of the tire and tire inner temperature.

3. The road surface state determination method according to claim 2, wherein determination of the road surface state is not performed in a case where the state information has exceeded a preset range.

4. The road surface state determination method according to claim 1, wherein the determination parameter is a vibration level of a specific frequency band extracted from the vibration waveform or a calculated value calculated from vibration levels of a plurality of specific frequency bands.

5. The road surface state determination method according to claim 1, wherein the determination parameter is a range of a specific frequency band.

6. The road surface state determination method according to claim 1, wherein the determination parameter is a time width of a window by which the vibration waveform is multiplied.

7. The road surface state determination method according to claim 1, wherein the determination parameter is a weight vector of a determination function using vibration levels of a plurality of specific frequency bands used for road surface determination, or an intermediate parameter of the weight vector.

8. The road surface state determination method according to claim 1, wherein the determination parameter is an output value of a determination function using vibration levels of a plurality of specific frequency bands used for road surface determination.

9. A road surface state determination apparatus comprising:
a vibration detection means that detects vibration of a tire during travel;
a vibration waveform detection means that detects a time-varying waveform of the vibration of the tire; and
a road surface state determination means that determines a state of a road surface from the time-varying waveform,
wherein a tire state detection means that obtains state information of the tire is provided, and
wherein the road surface state determination means determines a road surface state from a determination parameter that is obtained from the vibration waveform and is for determining the road surface state, and from the state information.

10. A road surface state determination apparatus comprising:
a vibration detection means that detects vibration of a tire during travel;
a vibration waveform detection means that detects a time-varying waveform of the vibration of the tire; and
a road surface state determination means that determines a state of a road surface from the time-varying waveform,
wherein a tire state detection means that obtains state information of the tire and a parameter correction means that corrects, by using the state information, a determination parameter that is obtained from the vibration waveform and is for determining a road surface state are provided, and
wherein the road surface state determination means determines the road surface state from the determination parameter corrected by using the state information.

11. A road surface state determination method for determining a state of a road surface from a time-varying waveform of vibration of a tire during travel detected by a vibration detection means, the road surface state determination method comprising:
a step of obtaining a vibration waveform of the tire;
a step of obtaining external information input to the tire; and
either one determination step of a first determination step of determining a road surface state from a determination parameter that is obtained from the vibration waveform and is for determining the road surface state, and from the external information, and a second determination step of determining the road surface state, after correcting or changing the determination parameter by using the external information, from the corrected determination parameter.

12. The road surface state determination method according to claim 11, wherein the external information is braking/driving force applied to the tire.

13. The road surface state determination method according to claim 12, wherein determination of a road surface state is not performed in a case where the external information has exceeded a preset range.

14. The road surface state determination method according to claim 11, wherein the determination parameter is a vibration level of a specific frequency band extracted from the vibration waveform or a calculated value calculated from vibration levels of a plurality of specific frequency bands.

15. The road surface state determination method according to claim 11, wherein the determination parameter is a range of a specific frequency band.

16. The road surface state determination method according to claim 11, wherein the determination parameter is a time width of a window by which the vibration waveform is multiplied.

17. The road surface state determination method according to claim 11, wherein the determination parameter is a weight vector of a determination function using vibration levels of a plurality of specific frequency bands used for road surface determination, or an intermediate parameter of the weight vector.

18. The road surface state determination method according to claim 11, wherein the determination parameter is an output value of a determination function using vibration levels of a plurality of specific frequency bands used for road surface determination.
